(19) United States
(12) Patent Application Publication
(10) Pub. No.: US 2016/0017208 A1
(43) Pub. Date: Jan. 21, 2016

(54) MICROBIAL CONCRETION AS A METHOD FOR CONTROLLING WORMHOLE EVENTS DURING OIL RECOVERY FROM UNCONSOLIDATED MATRICES

(71) Applicant: THE REGENTS OF THE UNIVERSITY OF CALIFORNIA, Oakland,, CA (US)

(72) Inventor: John D. COATES, Walnut Creek, CA (US)

(73) Assignee: THE REGENTS OF THE UNIVERSITY OF CALIFORNIA, Oakland, CA (US)

(21) Appl. No.: 14/775,645

(22) PCT Filed: Feb. 21, 2014
(86) PCT No.: PCT/US14/17831

§ 371 Date: Sep. 11, 2015

Related U.S. Application Data
(60) Provisional application No. 61/799,403, filed on Mar. 15, 2013.

(51) Int. Cl. C09K 8/58

(52) U.S. Cl. CPC C09K 8/58

(57) ABSTRACT

The present disclosure relates to methods of controlling wormhole formation in a borewell environment of reservoir systems, such as oil reservoirs, by inducing authigenic mineral-precipitating bacteria to precipitate authigenic rock minerals that consolidate unconsolidated rock matrices.

### CROSS-REFERENCE TO RELATED APPLICATION

This application claims the benefit of U.S. Provisional patent application Ser. No. 61/799,403 filed Mar. 15, 2013, which is hereby incorporated by reference, in its entirety.

### BACKGROUND

1. Field

The present disclosure relates generally to methods of controlling wormhole formation in subterranean reservoir systems and, more specifically, to methods of controlling wormhole formation in a borewell environment.

2. Description of Related Art

In secondary oil recovery, oil production is driven by the injection of fluids, generally water, into the oil reservoir and a water sweep across the reservoir starting at the injection well and driving out crude oil at the production well (FIG. 1A). This process is also known as the waterflood process. In the early stages of oil production from an oil field, the pressure difference between the bottom hole injection well and the bottom hole production well is generally on the order of 1,000 to 2,000 psi, and -often between 1,200 to 1,500 psi in a normal heavy/viscous oil waterflood (see, e.g., Patent Application Publication No. US 2011/0024115).

However, as the oil field matures, pressure communication frequently develops between injection and production wells causing sudden significant pressure drops (i.e. pressure drops on the order of at least 100 psi over a 12 hour time period). As a result, water breaks through at the production well, water-to-oil ratios increase in production fluids, and oil production decreases. In severe cases, also referred to as “matrix bypass events” (MBEs), the waterflood process can fail completely and the bottom hole injection and production pressures essentially equalize. In these severe cases, pressure differentials of less than 200 psi, and in extreme cases of less than 100 psi, typically remain between injection and production well bottoms. MBEs are a particular problem in the waterflooding of many heavy/viscous oil reservoirs, which use a cold production method such as CHOPS (Cold Heavy Oil Production with Sand).

Pressure communication is often initiated through geological erosion events in the immediate borewell environments. One well documented erosion event frequently occurs in the CHOPS process and results in the formation of so-called “wormholes.” Wormholes are tunnel-like structures originating at borewells and radiating into the surrounding rock matrices. Wormholes are formed as fines in unconsolidated rock matrices are removed from the reservoir rock during production of oil/sand mixtures. Fine removal is thought to cause the permeability of the rock to increase as the wormhole develops. Over time, the rock matrix weakens up to the point where a portion of the rock formation can fail and leave a “void” in the reservoir. Until a void is formed, the enhanced permeability area in the rock matrix where the fines have been removed is also called the “halo.” Thus wormholes may contain either void spaces, or halo regions, or both (see, e.g., FIG. 1B, Patent Application Publication No. US 2011/0024115, Tremblay et al. “Simulation of Cold Production in Heavy-Oil Reservoirs: Wormhole Dynamics,” SPE Reservoir Engineering (May 1997) at pages 110-117; U.S. Pat. No. 7,677,313). When wormholes expand far enough into a reservoir's rock matrix to connect the injection and production wells, a “wormhole channel” is formed (FIG. 1B).

Whereas wormholes are known to originate at the production well and to grow out into the reservoir matrix towards the injection well, a complementary phenomenon, so-called “(viscous) fingering” or “water fingering,” is known to arise from the injection well during the waterflood process in heavy oil recovery. Viscous fingering occurs when a lower viscosity fluid, such as water, is injected into a higher viscosity fluid, such as crude oil. The emerging fluid interface is not homogenous; instead the injected lower viscosity fluid develops finger-like extensions that appear to reach into the higher viscosity fluid. The shape and extent of finger formation is impacted both by the relative fluid viscosities and the porosity and heterogeneity of the rock matrix. In conjunction with wormhole formation, viscous fingering facilitates the development of pressure communication between injection and production wells and thereby ultimately facilitates the occurrence of MBEs.

When both producer and injector wells are active in a heavy/viscous oil waterflood, it is believed that a wormhole from the producer side seeks the relatively high pressure source of the injector well and, correspondingly, a water finger from the injector side seeks the lower pressure of the producer well. When this finger of water connects to the wormhole of the producer, the water-oil ratio of the produced fluids increases dramatically and becomes a pressure communication between the injector and the producer (see, e.g., Patent Application Publication No. US 2011/0024115). Eventually, a wormhole channel forms and an MBE occurs (FIG. 1B). The subsequent short circuiting of injected water can make the waterflood process ineffective and oil recovery economically unfeasible. Consequently, effective and economical methods are needed to prevent the initiation and suppress the further expansion of pressure communication through wormholes and water fingers.

Current methods generally focus on plugging fully developed wormholes after an MBE has occurred (see, e.g., Patent Application Publication No. US 2011/0024115 and U.S. Pat. No. 7,677,313). Commonly, the injection of gels or cement compositions into the wormhole void and halo regions is proposed. Id. Microbial plugging systems have also been proposed (see, e.g., U.S. Pat. No. 4,460,043, U.S. Pat. No. 4,561,500, U.S. Pat. No. 5,143,155). However, such methods may only be temporarily effective because artificial plugs are unlikely to remain stable over extended time periods and the plugged wormholes can reopen. More importantly, the plugging of existing wormholes does not prevent the formation of new wormholes that can bypass the plug. Consequently, additional MBEs are bound to occur in the future and the plugging procedure will have to be applied in a repeated fashion. Moreover, it is expected that, as the oil field matures and subterranean rock matrices continue to erode, wormhole plugging will become increasingly difficult to achieve in an increasingly fractured rock matrix.

Therefore, effective methods are needed to prevent or slow down the development of wormholes either prior to the occurrence of an MBE or after a previously formed wormhole has been plugged using traditional methods.

### BRIEF SUMMARY

In order to meet the above needs, the present disclosure provides methods to prevent or control wormhole formation in subterranean reservoir systems and, more specifically, to methods of controlling wormhole formation in a borewell environment.

Certain aspects of the present disclosure relate to a method of controlling wormhole formation in a borewell environment by microbial concretion by: a) providing a system comprising a borewell and a borewell environment, wherein the borewell environment comprises an unconsolidated rock matrix and authigenic mineral precipitating bacteria; b) providing an authigenic mineral precursor solution and an authigenic mineral-precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby controlling wormhole formation in the borewell environment.

Other aspects of the present disclosure relate to creating a permeable zone of stable petrology in a borewell environment by microbial concretion by: a) providing a system comprising a borewell and a borewell environment, wherein the borewell environment further comprises an unconsolidated rock matrix and authigenic mineral precipitating bacteria; b) providing an authigenic mineral precursor solution and an authigenic mineral-precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic material consolidates the unconsolidated rock matrix, thereby creating a permeable zone of stable petrology in the borewell environment.

Additional aspects of the present disclosure relate to a method of creating a permeable zone of stable petrology in a borewell environment by microbial concretion by: a) providing a system comprising a borewell and a borewell environment, wherein the borewell environment further comprises an unconsolidated rock matrix and authigenic mineral precipitating bacteria; b) providing an authigenic mineral precursor solution and an authigenic mineral-precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic material consolidates the unconsolidated rock matrix, thereby creating a permeable zone of stable petrology in the borewell environment.

Still other aspects of the present disclosure relate to a method of reducing the drop in water pressure of floodwater in oil recovery by microbial concretion by: a) providing a system comprising a borewell and a borewell environment, wherein the borewell environment further comprises an unconsolidated rock matrix, floodwater, and authigenic mineral-precipitating bacteria; b) providing an authigenic mineral precursor solution and an authigenic mineral-precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby reducing the drop in water pressure of floodwater in oil recovery.

Additional aspects of the present disclosure relate to a method of controlling waterfinger formation in an injection well environment by microbial concretion by, a) providing a system comprising an injection well and an injection well environment, wherein the injection well environment comprises an unconsolidated rock matrix and authigenic mineral precipitating bacteria; b) providing an authigenic mineral precursor solution and an authigenic mineral-precipitation inducer; and c) contacting the injection well environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby controlling waterfinger formation in the injection well environment.

In some embodiments, the precipitated authigenic mineral comprises at least one authigenic precipitation partner and wherein at least one precipitation partner was added to the system. In further embodiments, the at least one precipitation partner is Ca2+, Mg2+, NH4+, PO43-, CO32-, or F—. In other embodiments, the precipitation partner is added in combination with the authigenic mineral precursor. In additional embodiments, the precipitation partner is added in combination with the authigenic mineral precursor and the authigenic mineral precipitation inducer. In additional embodiments, the precipitation partner is added in excess to the authigenic mineral precursor.

In some embodiments, the borewell is an injection well or a production well. In some embodiments, the system comprises a first borewell and borewell environment, which is an injection well and an injection well environment, and a second borewell and a second borewell environment, which is a production well and a production well environment. In additional embodiments, the contacting comprises contacting both the injection well environment and the production well environment with the authigenic mineral precursor solution and the authigenic mineral-precipitation inducer. In further embodiments, the pressure differential between the injection well and the production well are compared prior to execution of step c) and after completion of step c) of the methods described above. In further embodiments, the system has not experienced a Matrix Bypass Event and wherein no pressure communication has been established between the injection well and the production well prior to the execution of step c).

In some embodiments, a pressure communication has been established between the injection well and the production well, but no Matrix Bypass Event has occurred prior to execution of step c). In some embodiments, a Matrix Bypass Event has occurred and wherein additional steps were taken to stabilize the pressure prior to execution of step c). In further embodiments, the pressure was stabilized by injecting plugging compositions into the system or by precipitating authigenic rock mineral in the system.

In some embodiments, the contacting comprises contacting the authigenic mineral precursor solution and the authigenic mineral-precipitation inducer with the borewell environment at the same time.

In some embodiments, the borewell environment is contacted with the authigenic mineral precursor solution and an authigenic mineral-precipitation inducer under conditions whereby the inducer further induces the precursor to chemically precipitate authigenic rock mineral from the solution into the unconsolidated rock matrix, wherein the precipitated authigenic mineral consolidates the unconsolidated rock matrix.

In some embodiments, the system is selected from the group consisting of an oil reservoir; a natural gas reservoir; an aquifer; a wastewater reservoir containing effluent from a pulp, paper, or textile mill or a tannery; and a CO2 storage well. In some embodiments, the system is an oil reservoir. In additional embodiments, oil flow and flood water sweep in a reservoir during secondary or tertiary recovery is increased. In additional embodiments, oil recovery is increased. In some embodiments, the system further contains a ground contaminant. In some embodiments, the unconsolidated rock matrix contains CO2. In some embodiments, prior to step a), the authigenic mineral-precipitating bacteria are added to the system. In additional embodiments, the added authigenic mineral-precipitating bacteria are recombinant bacteria.

In some embodiments, the authigenic mineral-precipitating bacteria are selected from the group consisting of iron-reducing bacteria, iron-oxidizing bacteria, nitrate-dependent Fe(II)-oxidizing bacteria, fermentative bacteria, phosphite-oxidizing bacteria, perchlorate-reducing bacteria, chlorate-reducing bacteria, nitrate-reducing bacteria, urea oxidizing bacteria, calcium mineral precipitating bacteria, apatite mineral precipitating bacteria, ammonium carbonate mineral-precipitating bacteria, magnesium mineral precipitating bacteria, silicate mineral precipitating bacteria, manganese mineral-precipitating bacteria, sulfur mineral-precipitating bacteria, iron-precipitating bacteria, phosphorous mineral-precipitating bacteria. In some embodiments, the authigenic mineral-precipitating bacteria are iron-oxidizing bacteria, nitrate-dependent Fe(II)-oxidizing bacteria, phosphorous mineral precipitating bacteria or phosphite oxidizing bacteria. In some embodiments, the authigenic mineral-precipitating bacteria are Pseudogulbenkiania sp. strain 2002, Azospira suillum, Desulfotignum phosphitoxidans sp., Acidovorax sp., or Pseudomonas sp.

In some embodiments, the authigenic mineral precursor solution is selected from the group consisting of an Fe(II) solution, an ammonia solution, a urea solution, a phosphate solution, a phosphite solution, a calcium solution, a carbonate solution, and a magnesium solution. In another embodiment, the authigenic mineral precursor solution is a Fe(II) solution, a urea solution, or a phosphite solution. In some embodiments, the authigenic mineral-precipitation inducer is selected from the group consisting of nitrate, nitrite, nitrous oxide, nitric oxide, perchlorate, chlorate, chlorite, chlorine dioxide, Fe(III), carbonate, bicarbonate, CO2, sulfate, and oxygen. In another embodiment, the authigenic mineral-precipitation inducer is nitrate, sulfate, carbonate, bicarbonate, or CO2.

In some embodiments, the authigenic mineral precipitation is the result of a reversible reaction. In another embodiment, the reversible reaction is a redox reaction.

In some embodiments, the contacting comprises contacting the authigenic mineral precursor solution with the borewell environment first, and contacting the authigenic mineral-precipitation inducer with the borewell environment second.

In some embodiments, the authigenic mineral is selected from a group consisting of calcium carbonate, calcium sulfate, calcium phosphate, magnesium carbonate, magnesium phosphate, ferric oxide, ferric oxyhydroxide, mixed valence iron minerals, ferric phosphate, ferrous phosphate, ferric carbonate, ferrous carbonate, manganese oxides, mixed valence manganese minerals and ammonium phosphates. In one embodiment, the authigenic mineral is an apatite or struvite mineral. In another embodiment, the authigenic mineral is the carbonate fluoroapatite [Ca10(PO4,CO3)6F2].

In some embodiments, precipitated authigenic minerals extend up to 0.5 meter, 1 meter, 1.5 meters, 2.0 meters, 2.5 meters, 3.0 meters, 4 meters, 5 meters, 6 meters, 7 meters, 8 meters, 9 meters, 10 meters, 15 meters, 20 meters, 30 meters, 50 meters, 100 meters, 150 meters, 200 meters, 300 meters, 400 meters, or 500 meters 1,000 meters, 2,000 meters, 3,000 meters, 4,000 meters, or 5,000 meters away from the borewell.

In some embodiments, the precipitated authigenic rock minerals consolidate up to 1%, 2%, 4%, 6%, 8%, 10%, 15%, 20%, 30%, 40%, 50%, 60%, 70%, 80%, 90%, 95%, 98%, 99%, 99.9% of the unconsolidated rock matrix in the borewell environment.

In some embodiments, the density of the consolidated rock matrix is highest in direct proximity to the borewell bottom and decreases from the borewell bottom towards the outer limits of the borewell environment.

In some embodiments, the density of the consolidated rock matrix at the outer limits of the borewell environment has decreased by at least 1%, 2%, 3%, 4%, 5%, 6%, 7%, 8%, 9%, 10%, 15%, or 20% relative to the density of the rock matrix in direct proximity to the borewell bottom.

In some embodiments, the precipitation of authigenic minerals and rock matrix consolidation reduces the content of fines or particulate matter in production fluids or gases by at least 1%, 5%, 10%, 15%, 20%, 30%, 40%, 50%, or 60%, relative to the content of fines or particulate matter observed prior to exposure to the authigenic mineral precursor solution and the authigenic mineral-precipitation inducer.

In some embodiments, the borewell is an injection well and authigenic mineral precipitation and matrix consolidation reduces the pressure differential between injection well environment areas having unconsolidated rock matrix and the injection well bottom by at least 10%, 20%, 30%, 40%, 50%, 60%, 70% or 80% relative to the pressure differential observed prior to exposure to the authigenic mineral precursor solution and the authigenic mineral-precipitation inducer.

In some embodiments, after exposure to the authigenic mineral precursor solution and the authigenic mineral-precipitation inducer, the pressure differential between injection well and production well bottoms increases by at least 1%, 3%, 5%, 10%, 20%, 30%, 40%, or 50% relative to the pressure differential observed prior to exposure to the authigenic mineral precursor solution and the authigenic mineral-precipitation inducer.

### DESCRIPTION OF THE FIGURES

FIG. 1A diagrammatically depicts secondary and tertiary oil recovery from an oil reservoir. Water is injected at an injection well into an oil reservoir to maintain reservoir pressure and to sweep oil from the injection well towards the production well. FIG. 1B diagrammatically depicts the consequences of a Matrix Bypass Event (MBE), a phenomenon frequently occurring in mature oil reservoirs. When oil is first recovered from a field, tunnel-like structures, so-called “wormholes,” develop at borewells, such as a production well, and start radiating away from the borewell and out into the surrounding rock matrix. As the wormholes expand further, pressure communication develops between the injection and production well bottoms. At the same time, increasing amounts of sand and water are produced at the production well, while oil recovery is gradually reduced. Finally, when a Matrix Bypass Event (MBE) occurs, the pressure differential between injection and production wells breaks down almost entirely and a “wormhole channel” is formed that short-circuits the injection and production wells of the oil reservoir. This channel often contains a water-filled void region and a rock matrix “halo” region with decreased rock density. As a result of wormhole channel formation, water can cycle directly between the injection well and the production well, while bypassing the reservoir matrix. When this happens, the water sweep depicted in FIG. 1A breaks down.

FIG. 2A diagrammatically illustrates the sharp pressure drops occurring at the water-rock interface at the injection well bottom (ΔP_{I1}) and the oil-rock interface at the production well bottom (ΔP_{P1}). Without wishing to be bound by theory, it is believed that these pressure drops at fluid-rock interfaces in borewell environments contribute to the initiation of wormhole formation. At the injection well, unconsolidated rock matrices are fluidized by high-pressure water injections, which results in the development of a wormhole. At the production well, unconsolidated fines are washed out of the rock matrix along with the production fluid, thereby creating lower density rock formations, also referred to as wormholes. FIG. 2B diagrammatically depicts the effect of consolidating rock matrices (depicted as shaded circular areas) in borewell environments. Without wishing to be bound by theory, it is believed that consolidated rock matrices can create permeable zones of stable petrology immediately surrounding the borewells and thereby disperse the sharp pressure drops at the fluid-rock interfaces of borewell bottoms. The remaining pressure drops at the interfaces of consolidated to unconsolidated rock matrices are believed to be much smaller than the pressure drops observed at fluid-rock interfaces in the absence of matrix concretion (ΔP_{I1}>ΔP_{I2}; ΔP_{P1}>ΔP_{I2}). It is believed that by diffusing sharp pressure drops at borewell bottoms matrix concretion can help control wormhole formation and expansion.

FIG. 3 depicts MPN enumeration of FRC nitrate dependent Fe(II) oxidizers.

FIG. 4 shows an Unrooted Neighbor-Joining phylogenetic tree of the 16S rRNA gene sequence from nitrate-dependent Fe(II) oxidizing bacteria.

FIG. 5 graphically depicts mixotrophic Fe(II) oxidation coupled to nitrate reduction and growth with acetate by strain TPSY.

FIG. 6 graphically depicts lithoautotrophic growth by Pseudogulbenkiania strain 2002 using Fe(II) and nitrate as the electron donor and acceptor, respectively, and CO₂ as the sole carbon source.

FIG. 7 graphically depicts Fe(II) oxidation by A. suillum in anoxic culture medium with acetate as the carbon source and nitrate as the sole electron acceptor. Fe(II) oxidation only occurred after acetate utilization was complete.

FIG. 8 graphically depicts sand-packed column designs modeling the production well and injection well environments of an oil reservoir. The sand-packed columns are divided into two chambers, a fluid chamber and a matrix chamber. A piston exerts pressure on the fluid in the fluid chamber and pushes the fluid through the matrix in the second chamber. FIG. 8A shows a sand-packed column modeling a production well environment. In this column, the effluent exits the matrix chamber through an outlet (corresponding to the production well) that has a much smaller diameter and surface area than the porous disk that allows the influent to enter the matrix chamber (see also, e.g., FIG. 2 in Tremblay et al. “Simulation of Cold Production in Heavy-Oil Reservoirs: Wormhole Dynamics,” SPE Reservoir Engineering (May 1997) at pages 110-117). In contrast, the sand-packed column shown in FIG. 8B models the injection well. Here the influent enters the matrix chamber through a narrow inlet (corresponding to the injection well), but the fluid exits the chamber through a much wider disk.

### DETAILED DESCRIPTION

### Definitions

As used herein, “authigenic mineral”, “authigenic rock mineral”, and “sedimentary rock” are used interchangeably and refer to mineral deposits that develop from soluble chemicals (e.g., ions and organic compounds) in sediments.

As used herein, “authigenic mineral-precipitating bacteria” refers to bacteria that are able to utilize an authigenic mineral precursor solution to precipitate an authigenic mineral. For example, phosphite oxidizing bacteria are a type of “authigenic mineral-precipitating bacteria” that oxidize soluble phosphite (PO₃³⁻) to phosphate (PO₄³⁻) precipitates. In another example, urea oxidizing bacteria are a type of “authigenic mineral-precipitating bacteria” that oxidize soluble urea to insoluble carbonate (CO₃²) precipitates. In another example, nitrate-dependent Fe(II)-oxidizing bacteria are a type of “authigenic mineral-precipitating bacteria” that oxidize soluble Fe(II) to Fe(III) precipitates.

As used herein, an “authigenic mineral precursor solution” refers to a solution that contains the substrate, such as soluble ions, that is used by authigenic mineral-precipitating bacteria to form a mineral precipitate. For example, a phosphite (PO₃³⁻) solution may be utilized by phosphite oxidizing bacteria to convert soluble phosphite to a phosphate (PO₄³⁻) precipitate. In another example, a urea solution may be utilized by urea oxidizing bacteria to convert soluble urea to insoluble carbonate precipitates. In another example, Fe(II) solution may be utilized by nitrogen-dependent Fe(II)-oxidizing bacteria to convert soluble Fe(II) to a Fe(III) precipitate.

As used herein, an “authigenic mineral-precipitation inducer” refers to a composition, for example, a chemical, ionic salt, electron donor, electron acceptor, redox reagent, etc., that induces, in the authigenic mineral-precipitating bacteria, a reversible authigenic mineral-precipitating reaction. For example, an authigenic mineral-precipitation inducer may be an oxidizing agent (i.e., an electron acceptor) that allows the bacteria to precipitate an authigenic mineral from an authigenic mineral precursor solution by oxidizing the precursor solution.

As used herein, an “authigenic mineral precipitation partner” refers to a composition, for example a chemical or ionic salt, which participates in the precipitation of authigenic minerals without being a substrate for the authigenic mineral precipitating bacteria. For example, Ca²⁺, Mg²⁺, NH₄⁺ may participate in the precipitation of authigenic phosphate minerals resulting from the oxidation of phosphite (i.e., the authigenic mineral precursor) by phosphate oxidizing bacteria. The precipitation partners of this disclosure may be naturally present in the systems of this disclosure or they may be added to the systems, regardless of whether they are naturally present or not.

As used herein “chemical precipitation of authigenic rock mineral” and “chemically precipitated authigenic rock mineral” refers to authigenic rock mineral that is precipitated as a result of a chemical reaction and without the involvement of authigenic mineral-precipitating bacteria.

As used herein “wormhole” refers to a higher permeability passage in a rock matrix surrounding a borewell, such as an injection well or a production well. This higher permeability passage originates at the borewell bottom and radiates away from the borewell and out into the surrounding rock matrix. Typically, the wormholes of this disclosure are caused by rock matrix erosion due to the injection of fluids or gases into the rock matrix or the production of fluids or gases from the rock matrix. During this rock matrix erosion, unconsolidated rock matrix particles, such as fines or other fine-grained rock matter, are removed from the rock matrix, thereby creating the higher permeability passage or “wormhole.” The wormholes of this disclosure may contain “halo” regions, in which unconsolidated matrix particles have been partially removed from the rock. However, the wormholes may also contain “void” regions, where the removal of unconsolidated rock matrix particles has weakened the rock matrix to the point where a portion of the rock formation can fail. Thus, as used herein, wormholes may contain either void spaces, halo regions or both.

As used herein “wormhole channel” refers to a higher permeability structure in a reservoir's rock matrix that connects and short-circuits an injection and production well. Typically, the formation of a wormhole channel results in a rapid pressure drop between the injection and production wells, a breakthrough of water at the production well, and a substantial reduction in oil recovery.

As used herein “controlling wormhole formation” refers to the prevention of initial wormhole formation as well as the suppression of expansion of an existing wormhole.

As used herein “consolidating an unconsolidated rock matrix” means affecting any changes in the rock matrix that decrease the mobility of any rock matrix matter within the rock matrix. For example, the term includes increasing the relative granularity of particulate matter in the matrix, such as turning relatively fine-grained matter into coarser-grained matter. Also included are changes in the matrix that immobilize particulate matter, such as fines, on immobile elements of the matrix or that combine fine-grained particles in a single immobile phase. Moreover, the term also covers any changes in the rock matrix decreasing the relative porosity of the matrix. Additionally, chemical processes such as the precipitation of previously soluble rock matrix components into particulate matter or concretized matter are covered by the term as used herein.

As used herein a “borewell” means any narrow shaft bored in the ground, either vertically or horizontally. A borewell may be constructed for many different purposes, including the extraction of water or other liquid (such as petroleum) or gases (such as natural gas), as part of a geotechnical investigation, environmental site assessment, mineral exploration, temperature measurement or as a pilot hole for installing piers or underground utilities. Also borewells can be made for geothermal installations. As well as pumping petroleum from an underground well through a borewell, liquid or gas can be pumped into it, for that process, or for underground storage of unwanted substances.

As used herein a “borewell environment” means the subsurface environment immediately surrounding the borewell with which the borehole fluids (gases or liquids) are in contact. The borewell environment may extend out to 5,000 meters from the borewell.

### Overview

The following description sets forth exemplary methods, parameters and the like. It should be recognized, however, that such description is not intended as a limitation on the scope of the present disclosure but is instead provided as a description of exemplary embodiments.

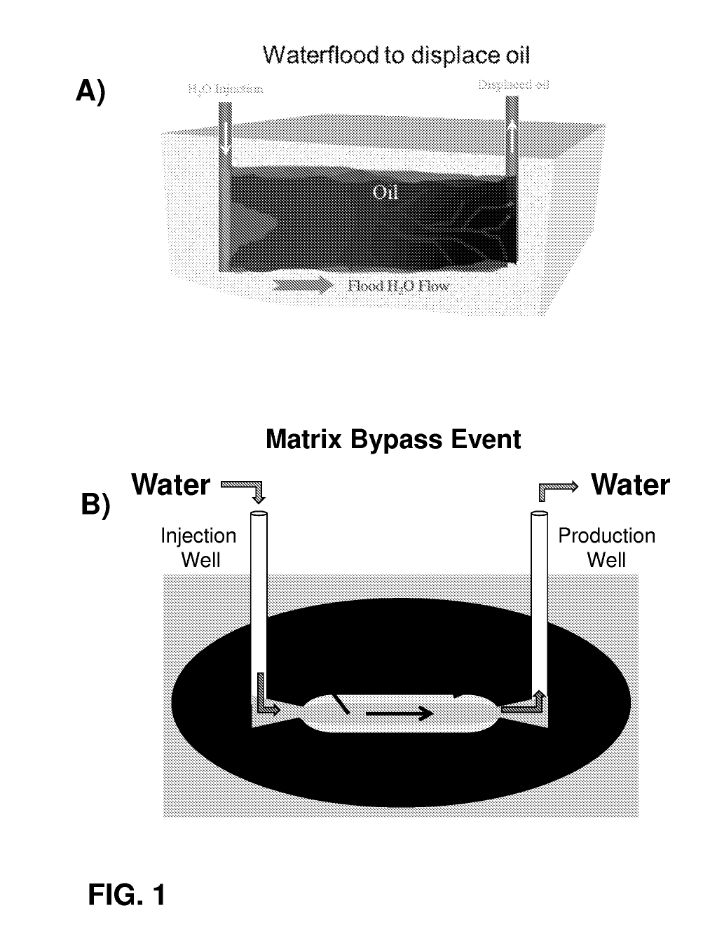

The waterflood process is commonly used in secondary oil recovery. It involves driving oil out of the production well by sweeping water across the reservoir system (FIG. 1A). However, over time, waterflooding can erode the unconsolidated rock matrices in the reservoir and result in the development of direct pressure communications between the injection and production wells, also known as “wormholes.” Wormhole formation, often in combination with a second phenomenon called “water-fingering,” can short-circuit the injected water, increase water-to-oil ratios in production fluids, and reduce oil recovery (FIG. 1B). While methods are known for plugging wormholes once they are formed, these methods generally do not prevent the formation of new wormholes and therefore only offer temporary solutions to recovery problems in maturing oil fields.

The present disclosure relates to methods of controlling the initiation of wormhole formation as well as the further expansion of existing wormholes. The methods of the present disclosure achieve this wormhole control by utilizing authigenic mineral-precipitating bacteria to precipitate authigenic minerals in the rock matrices of the borewell environments of a subterranean reservoir system and thereby consolidate the unconsolidated rock matrices.

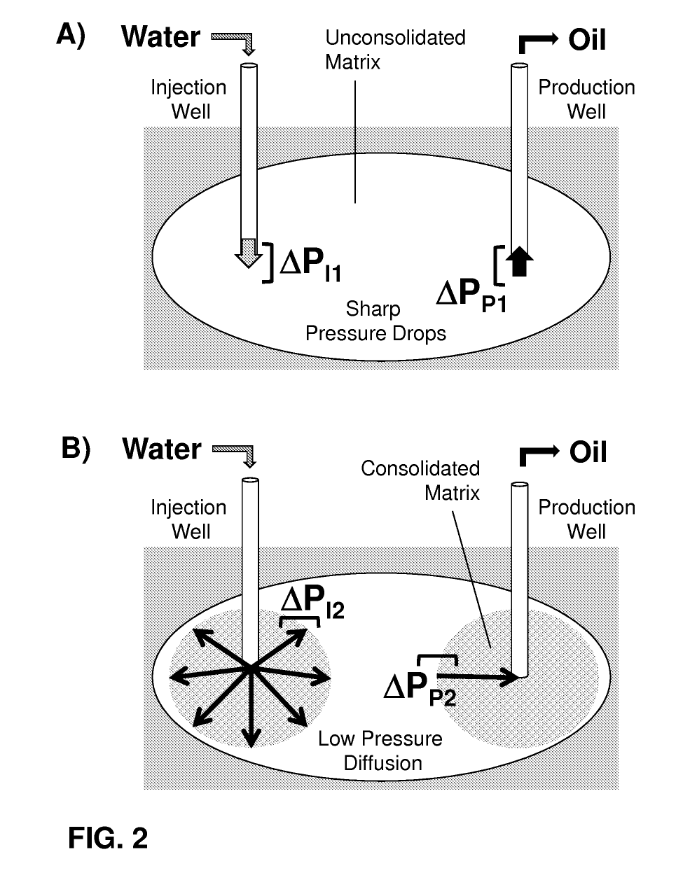

Without wishing to be bound by theory, it is believed that wormhole formation is generally driven by the erosive impact of fluid-matrix pressure differentials on the unconsolidated rock matrices in borewell environments. In the production well environment, unconsolidated rock matrices are exposed to steep pressure drops at the oil-to-rock interface at the production well bottom, where production fluids are exiting the reservoir system and unconsolidated matrices are washed out of the system along with the production fluids (FIG. 2A, ΔP_{P1}). On the other hand, wormhole initiation at the injection well bottom is believed to result from the large pressure drop at the water-rock interface, where water is exciting the injection well and entering the unconsolidated reservoir matrix (FIG. 2A, ΔP_{I1}). This pressurized water entry into the rock results in the fluidization of the matrix in the injection well environment and the initiation of wormhole formation.

Furthermore, without wishing to be bound by theory, it is believed that the continued weakening of rock matrices in the waterflood process can be controlled by consolidating rock matrices in borewell environments. Through the concretion of unconsolidated rock matrices permeable zones of stable petrology are created that diffuse the steep and localized pressure drops at borewell bottoms (FIG. 2A, ΔP_{P1} and ΔP_{I1}) over a greater distance and over a larger surface area at the outer reaches of the consolidated rock matrices (FIG. 2B, ΔP_{P2} and ΔP_{I2}). The spreading of pressure differentials results in much reduced pressure drops at the interface of consolidated and unconsolidated matrices relative to the steep localized pressure drops observed at the borewell-unconsolidated matrix interface (FIG. 2, ΔP_{P1}>ΔP_{P2} and ΔP_{I1}>ΔP_{I2}). Moreover, without wishing to be bound by theory, it is believed that matrix consolidation will result in a homogenization of the matrix porosity and thereby also help control the water-fingering phenomenon, especially at the injection well. The described effects, alone or in combination, are believed to prevent the removal of remaining fines in the reservoir and to slow down the initiation and expansion of wormhole developments.

Accordingly, the present disclosure provides methods of controlling wormhole formation in a borewell environment by microbial concretion, by a) providing a system comprising a borewell and a borewell environment, wherein the borewell environment comprises an unconsolidated rock matrix and authigenic mineral precipitating bacteria; b) providing an authigenic mineral precursor solution and an authigenic mineral-precipitation inducer; and contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic material consolidates the unconsolidated rock matrix, thereby controlling wormhole formation in the borewell environment.

The present disclosure also provides methods of creating a permeable zone of stable petrology in a borewell environment by microbial concretion, by a) providing a system comprising a borewell and a borewell environment, wherein the borewell environment further comprises an unconsolidated rock matrix and authigenic mineral precipitating bacteria; b) providing an authigenic mineral precursor solution and an authigenic mineral precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic material consolidates the unconsolidated rock matrix, thereby controlling wormhole formation in the borewell environment.

The present disclosure also provides methods of reducing the drop in water pressure of floodwater in oil recovery by microbial concretion, by a) providing a system comprising a borewell and a borewell environment, wherein the borewell environment further comprises an unconsolidated rock matrix, floodwater, and authigenic mineral-precipitating bacteria; b) providing an authigenic mineral precursor solution and an authigenic mineral-precipitation inducer; and c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby reducing the drop in water pressure of floodwater in oil recovery.

The present disclosure also provides methods of controlling waterfinger formation in an injection well environment by microbial concretion, by a) providing a system comprising an injection well and an injection well environment, wherein the injection well environment further comprises an unconsolidated rock matrix, floodwater, and authigenic mineral-precipitating bacteria; b) providing an authigenic mineral precursor solution and an authigenic mineral-precipitation inducer; and c) contacting the injection well environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby controlling waterfinger formation in the injection well environment.

In some embodiments of the methods described in paragraphs [0059]-[0062], oil flow and flood water sweep in the reservoir is increased during secondary or tertiary oil recovery. In some embodiments, oil recovery is increased.

In some embodiments of the method described in paragraphs [0059]-[0062], the system contains an injection well and an injection well environment and a production well and a production well environment; and both the injection well environment and the production well environment contain unconsolidated rock matrices and authigenic mineral precipitating bacteria. In certain embodiments, both the injection well environment and the production well environment are contacted with the authigenic mineral precursor solution and the authigenic mineral precipitation inducer. In certain embodiments, the methods described in paragraphs [0059]-[0062] further include d) comparing the pressure differential between the injection well and the production well prior to execution of step c) and after completion of step c).

### Exemplary Systems Treated

The methods of this disclosure can be used treat any system containing unconsolidated rock matrices. The systems of this disclosure generally are reservoir systems, such as oil reservoirs. Other examples of reservoir systems include natural gas reservoirs, aquifers, CO₂ storage wells, portable water aquifer systems, irrigation water aquifers, and wastewater reservoirs containing effluent from a pulp, paper, or textile mill or a tannery.

The systems of this disclosure generally have at least one or more borewells. The borewells can be injection wells, production wells, or other wells. Generally, the systems of this disclosure have at least one injection well and one production well. In the course of secondary recovery processes, a fluid, such as water, is injected at the injection well, while fluids or gases are produced at the production well. Generally, borewells are surrounded by borewell environments, such as injection well environments or production well environments. The borewell environments may extend up to 10 meters, 50 meters, 100 meters, 200 meters, 300 meters, 400 meters, 500 meters, 600 meters, 700 meters, 800 meters, 900 meters, 1,000 meters, 2,000 meters, 3,000 meters, 4,000 meters, or 5,000 meters away from the respective wells. The borewell environments may extent from the respective borewells in an approximately radial pattern. Alternatively, the shapes of the borewell environments may deviate from the radial pattern. Deviations from the radial pattern may result from the rock geology in the borewell environments, such as the presence of multiple rock layers featuring different degrees of rock density or porosity, as well as subsurface pressure differentials. The borewell environments generally contain an unconsolidated rock matrix and authigenic mineral precipitating bacteria. In some embodiments the authigenic mineral precipitating bacteria are indigenous in the borewell environments.

In some embodiments, the systems of this disclosure have not experienced a matrix bypass event (MBE) and pressure communication between the injection well and production well has not been established prior to execution of step c). In other embodiments, pressure communication has been established between the injection well and the production well, but no MBE has occurred prior to execution of step c). In other embodiments, a MBE has occurred and additional steps were taken to stabilize the pressure prior to execution of step c).

In certain embodiments the pressure communication or MBE resulted in a significant decrease of pressure between an injection well bottom and a production well bottom over a short period of time. In certain embodiments, the significant decrease in pressure was at least 100 psi, 200 psi, 300 psi, 400 psi, 500 psi, 600 psi, 700 psi, 800 psi, 900 psi, or 1,000 psi and the short time period was at most 6 hours, 12 hours, 18 hours, or 24 hours. In certain embodiments, the pressure was stabilized by injecting plugging compositions, such as gel or concrete compositions, into the system. In certain embodiments, the pressure was stabilized by precipitating authigenic rock minerals in the reservoir system. In certain embodiments, the establishment of a pressure communication or the occurrence of an MBE is indicated by an increase in water or particulate matter contents, such as sand, in the production gases or fluids. In certain embodiments, the water and particulate matter contents in the production gases or fluids increase by at least 5%, 10%, 25%, 50%, 75%, 100%, 250%, 500%, 750%, or 1,000% after establishment of the pressure communication or the MBE occurrence relative to the water or particulate matter contents prior to these events.

In some embodiments, the system further contains a ground contaminant, including, without limitation, radioactive pollution, radioactive waste, heavy metals, halogenated solvents, pesticides, herbicides, and dyes. In some embodiments, the system contains CO₂.

### Process for Treating the Borewell Environment

The methods of this disclosure provide for treatments of the borewell environments with an authigenic mineral precursor solution, and an authigenic mineral precipitation inducer. The inducer induces authigenic mineral precipitating bacteria to precipitate an authigenic mineral from the precursor solution into the unconsolidated rock matrix. The precipitated authigenic mineral consolidates the unconsolidated rock matrix in the borewell environments and thereby controls wormhole formation in the borewell environments.

In embodiments where the systems of this disclosure have at least one injection well and one production well, either the injection well or the production well are be treated with the authigenic mineral precursor solution and the authigenic mineral precipitation inducer. In certain embodiments, both the injection well environment and the production well environment are treated with the authigenic mineral precursor solution and the authigenic mineral precipitation inducer.

### Application of Authigenic Mineral Precursor Solutions and Authigenic Mineral-Precipitation Inducers

Generally, the precursor and inducer are contacted with the borewell environment by injecting solutions containing the precursor and inducer into a borewell. The borewell can be an injection well, a production well, or another well, such as a maintenance well.

According to this disclosure, if the precursor and inducer solutions are contacted with the production well environment through the production well, no gases or fluids are produced during this time. In some embodiments, waterflood and production of gases and fluids at the production well is also stopped if the precursor and inducer solutions are contacted with the injection well environment through the injection well. In some embodiments, the time period between completing the injection of the precursor and the inducer into the injection or production well environment and resuming the production of gases or fluids at the production well may amount to at least a 1 hour, 2 hour, 4 hour, 6 hour, 12 hour, 18 hour, 1 day, 2 day, 4 day, 6 day, 8 day, 16 day, 24 day, 32 day or longer period.

The authigenic mineral precursor solution and the authigenic mineral-precipitation inducer may be contacted with the production well environment concurrently or sequentially. In certain preferred embodiments, the production well environment is contacted with the precursor first and only subsequently contacted with the inducer. Accordingly, in some embodiments, the authigenic mineral precursor solution and the authigenic mineral-precipitation inducer are provided in a single composition. Alternatively, the authigenic mineral precursor solution and the authigenic mineral-precipitation inducer may be provided separately.

In some embodiments, an authigenic mineral precipitation partner may be added to the system. In certain embodiments, the precipitation partner may be added separately from the authigenic mineral precursor and the authigenic mineral-precipitation inducer. In certain other embodiments, the authigenic mineral precipitation partner may be added in combination with either the authigenic mineral precursor or the authigenic mineral precipitation inducer. In certain other embodiments, the authigenic mineral precipitation partner may also be added in combination with both the authigenic mineral precursor and the authigenic mineral precipitation inducer.

The production well environment may be contacted with the authigenic mineral precursor solution or the authigenic mineral precipitation inducer, or, optionally, the authigenic mineral precipitation partner, for time periods up to 6 hours, 12 hours, 18 hours, 1 day, 2 days, 4 days, 6 days, 8 days, 10 days, 12 days, or 14 days, either individually or in combination. In embodiments where the precursor and inducer are sequentially contacted with the production well environment the interim time period between contacting the production well environment with the precursor and the inducer may extend up to 6 hour, 12 hour, 18 hour, 1 day, 2 day, 4 day, or 6 day periods.

In embodiments where exogenous authigenic mineral-precipitating bacteria are added to a rock matrix-containing system, the authigenic mineral precursor solution and the authigenic mineral-precipitation inducer may be added to the system concurrently with the bacteria. In other embodiments, the authigenic mineral precursor solution and the authigenic mineral-precipitation inducer are added after the addition of bacteria.

In other embodiments, the ratio of authigenic mineral precursor solution to authigenic mineral—precipitation inducer is added to the rock matrix-containing system is at least 2:1, at least 3:1, at least 4:1, at least 5:1, at least 6:1, at least 7:1, at least 8:1, at least 9:1, at least 10:1, or more. In embodiments where the authigenic mineral precursor solution is a phosphite (PO₃³⁻) solution and the authigenic mineral-precipitation inducer is a calcium (Ca⁺) solution, the ratio of the PO₃³⁻ solution to Ca⁺ that is added to the rock matrix-containing system is at least 2:1, at least 3:1, at least 4:1, at least 5:1, at least 6:1, at least 7:1, at least 8:1, at least 9:1, at least 10:1, or more. Preferably, the ratio of PO₃³⁻ solution to Ca⁺ that is added to the rock matrix-containing system is 5:1. In embodiments where the authigenic mineral precursor solution is an Fe(II) solution and the authigenic mineral-precipitation inducer is nitrate, the ratio of the Fe(II) solution to nitrate that is added to the rock matrix-containing system is at least 2:1, at least 3:1, at least 4:1, at least 5:1, at least 6:1, at least 7:1, at least 8:1, at least 9:1, at least 10:1, or more. Preferably, the ratio of Fe(II) solution to nitrate that is added to the rock matrix-containing system is 5:1.

### Authigenic Mineral Precursor Solutions

As disclosed herein, authigenic mineral precursor solutions provide the substrate that is utilized by the authigenic mineral-precipitating bacteria to produce authigenic mineral. For example, in the case of PO₃³⁻-oxidizing bacteria, a PO₃³⁻ solution provides the soluble PO₃³⁻ substrate for the formation of calcium phosphate (apatite) mineral precipitates. In another example, in the case of Fe(II)-oxidizing bacteria, a Fe(II) solution provides the soluble Fe(II) substrate for the formation of iron oxide mineral precipitates.

Authigenic mineral precursor solutions of the present disclosure are provided to authigenic mineral-precipitating bacteria under conditions whereby the bacteria utilize the solution to precipitate authigenic mineral into a system of this disclosure containing an unconsolidated rock matrix.

Examples of suitable authigenic mineral precursor solutions include, without limitation, Fe(II) solutions, urea solutions, ammonia solutions, phosphate solutions, phosphite solutions, calcium solutions, carbonate solutions, and magnesium solutions. In preferred embodiments, the authigenic mineral precursor solutions are Fe(II) solutions, phosphite solutions, or urea solutions.

### Authigenic Mineral-Precipitation Inducers

As disclosed herein, authigenic mineral-precipitation inducers are solutions containing, for example, chemicals, ionic salts, chelators, electron donors, electron acceptors, or redox reagents that induce the authigenic mineral-precipitating activity in the authigenic mineral-precipitating bacteria. For example, in the case of phosphite oxidizing bacteria, carbonate can serve as the inducer, as its reduction is coupled to phosphite oxidation in the bacteria, which results in the precipitation of phosphate minerals. In another example, in the case of nitrate-dependent Fe(II)-oxidizing bacteria, nitrate can serve as the inducer, as its reduction is coupled to Fe(II) oxidization in the bacteria, which results in the precipitation of Fe(III) oxides.

Authigenic mineral-precipitation inducers of the present disclosure are provided to authigenic mineral-precipitating bacteria under conditions whereby the inducer induces the bacteria to reversibly precipitate authigenic mineral from an authigenic mineral precursor solution into a rock matrix-containing system of the present disclosure. Generally, the conditions will depend on the type of bacteria present in the rock matrix-containing system, the type of authigenic rock matrix present in the system, and the subsurface conditions of the rock matrix-containing system.

Examples of suitable authigenic mineral-precipitation inducers include, without limitation, phosphite, nitrous oxide, nitric oxide, nitrite, nitrate, perchlorate, chlorate, chlorite, chlorine dioxide, Fe(III), carbonate (CO₃²), bicarbonate (HCO₃⁻), CO₂, sulfate, and oxygen. In certain embodiments, combinations of these mineral-precipitation inducers may be used. In preferred embodiments, the authigenic mineral inducer solutions are phosphite solutions.

In some embodiments, the authigenic mineral precipitation inducer may induce the authigenic mineral precursor through a chemical reaction that does not involve the participation of authigenic mineral precipitating bacteria. These chemically precipitated authigenic rock minerals can consolidate an unconsolidated rock matrix and thereby control wormhole formation in a wormhole environment. In certain embodiments, the authigenic mineral-precipitating inducers NO or NO₂⁻, individually or in combination, oxidize the authigenic mineral precursor Fe(II) or Fe(III) and induce the chemical precipitation of Fe₂O₃. These authigenic precipitates can consolidate an unconsolidated rock matrix in a borewell environment.

### Authigenic Minerals

According to this disclosure, authigenic minerals precipitated in a borewell environment can consolidate unconsolidated rock matrices in this environment. Through such consolidation, wormhole formation in borewell environments can be controlled, a permeable zone of stable petrology can be created, and drops in floodwater pressures can be reduced during oil recovery. Generally, any authigenic mineral is useful that can be precipitated to coat rock matrices or facilitate the cohesion of unconsolidated matrix particles in a single phase and thereby promote the concretion of unconsolidated rock matrix particles.

Exemplary authigenic minerals that are able to consolidate unconsolidated rock matrices include, without limitation, calcium carbonate, calcium sulfate (gypsum), magnesium carbonate, ferric oxide, ferric oxyhydroxide (e.g., maghemite, hematite, goethite, etc.), mixed valence iron minerals (e.g., magnetite, green rust, etc.), ferric phosphate, ferrous phosphate, ferric carbonate, ferrous carbonate, manganese oxides and mixed valence manganese minerals (e.g., hausmannite, etc.). Preferably, apatite and struvite minerals, such as the carbonate fluoroapatite [Ca₁₀(PO₄,CO₃)₆F₂] are precipitated, e.g., following the bacterial oxidation of the soluble precipitation precursor phosphite (PO₃³⁻). Other preferred embodiments of precipitated authigenic minerals include calcium, magnesium, and ammonium phosphates.

In some embodiments, authigenic minerals are precipitated in the borewell environment around the bore well and may extend up to 0.5 meter, 1 meter, 1.5 meters, 2.0 meters, 2.5 meters, 3.0 meters, 4 meters, 5 meters, 6 meters, 7 meters, 8 meters, 9 meters, 10 meters, 15 meters, 20 meters, 30 meters, 50 meters, 100 meters, 150 meters, 200 meters, 300 meters, 400 meters, or 500 meters, 1,000 meters, 2,000 meters, 3,000 meters, 4,000 meters, or 5,000 meters away from the borewell. In some embodiments, the authigenic mineral precipitation occurs in a radial pattern.

In some embodiments, the precipitation of authigenic rock minerals consolidates up to 1%, 2%, 4%, 6%, 8%, 10%, 15%, 20%, 30%, 40%, 50%, 60%, 70%, 80%, 90%, 95%, 98%, 99%, 99.9% of the unconsolidated rock matrix in the borewell environment. In some embodiments, the density of the consolidated rock matrix is constant throughout the borewell environment. In other embodiments, the density of the consolidated rock matrix is highest in direct proximity to the borewell bottom and decreases from the borewell bottom towards the outer limits of the borewell environment. In certain embodiments, the density of the consolidated rock matrix at the outer limits of the borewell environment has decreased by at least 1%, 2%, 3%, 4%, 5%, 6%, 7%, 8%, 9%, 10%, 15%, or 20% relative to the density of the rock matrix in direct proximity to the borewell bottom.

In some embodiments, precipitation of authigenic minerals and rock matrix consolidation in a borewell environment reduces the content of fines or particulate matter in production fluids or gases by at least 1%, 5%, 10%, 15%, 20%, 30%, 40%, 50%, or 60%, relative to the content of fines or particulate matter observed prior to microbial concretion.

In some embodiments, prior to the induction of microbial concretion in the borewell environment, the water pressure at the injection well bottom (see, e.g., FIG. 2A, ΔP_{I1}) drops by at least 1%, 5%, 10%, 20%, 30%, 40%, 50%, 60%, 70%, or 80% when the floodwater enters the proximal unconsolidated injection well environment. Similarly, in some embodiments, prior to microbial concretion, the water pressure at the production well bottom (see, e.g., FIG. 2A, ΔP_{P1}) drops by at least 1%, 5%, 10%, 20%, 30%, 40%, 50%, 60%, 70%, or 80% when the production fluid enters the production well bottom from the unconsolidated production well environment. In some embodiments, microbial concretion reduces the pressure differential between borewell environment areas containing unconsolidated matrices and the borewell bottom by at least 10%, 20%, 30%, 40%, 50%, 60%, 70% or 80%. In some embodiments wherein the reservoir system either has not experienced an MBE or corrective steps have been taken to plug the MBE, microbial concretion increases the pressure differential between injection well and production well bottoms by at least 1%, 3%, 5%, 10%, 20%, 30%, 40%, or 50% relative to the pressure differential observed prior to microbial concretion.

### Authigenic Mineral-Precipitation Partner

In some embodiments, an authigenic mineral precipitation partner is added to the system. The precipitation partner is a composition, for example a chemical or ionic salt, that participates in the precipitation of authigenic minerals without being a substrate for the authigenic mineral precipitating bacteria. For example, the precipitation partners Ca²⁺, Mg²⁺, or NH₄⁺ may participate in the precipitation of authigenic phosphate minerals resulting from the oxidation of phosphite (as the authigenic mineral precursor) by phosphate oxidizing bacteria.

Precipitation partners may include, without limitation, Ca²⁺, Mg²⁺, NH₄⁺, PO₄³⁻, CO₃²⁻, and F. In some embodiments, the precipitation partner is added in combination with the authigenic mineral precursor. In certain embodiments, the precipitation partner is added in at least 2-fold, 4-fold, 8-fold, 16-fold, 32-fold, 64-fold, 128-fold, 256-fold, 512-fold, 1,000-fold, 10,000-fold or 100,000-fold excess over the precursor. In certain embodiments, at least 2, 3, 4, 5, 6, 7, 8, 9, or 10 precipitation partners may be added to the system.

### Authigenic Mineral-Precipitating Bacteria

Certain aspects of the present disclosure relate to methods of precipitating authigenic rock mineral by inducing authigenic mineral-precipitating bacteria that are present in systems containing rock matrix to precipitate authigenic mineral into a rock matrix. Examples of systems containing rock matrix include, without limitation, oil reservoirs, oil fields, aquifers, and subsurface geological formations.

Authigenic mineral-precipitating bacteria that are suitable for use with the methods of the present disclosure include both archaebacteria and eubacteria. Suitable authigenic mineral-precipitating bacteria also include aerobic bacteria and anaerobic bacteria that are be physchrophilic, mesophilic, thermophilic, halophic, halotolerant, acidophilic, alkalophilic, barophilic, barotolerant, or a mixture of several or all of these and intermediates thereof. Preferably, authigenic mineral-precipitating bacteria of the present disclosure are anaerobic bacteria, as anaerobic bacteria have suitable tolerance for the restricted availability of oxygen, extreme temperatures, extreme pH values, and salinity that may be encountered in the subsurface environments of the rock matrix-containing systems of the present disclosure.

Moreover, it has been previously shown that mineral-precipitating bacteria are ubiquitous and active in various environments, such as aquatic environments, terrestrial environments, and subsurface environments. Accordingly, authigenic mineral-precipitating bacteria of the present disclosure are able to sustain the metabolic activity that results in authigenic mineral precipitation in the subsurface environments of rock matrix-containing systems of the present disclosure.

Other examples of suitable authigenic mineral-precipitating bacteria include, without limitation, iron-precipitating bacteria, phosphorous mineral-precipitating bacteria, calcium mineral-precipitating bacteria, apatite mineral mineral-precipitating bacteria, and ammonium carbonate mineral-precipitating bacteria, magnesium mineral-precipitating bacteria, and silicate mineral-precipitating bacteria, manganese mineral-precipitating bacteria, and sulfur mineral-precipitating bacteria. Examples of such bacteria include, without limitation, Proteobacterial species, Escherichia species, Roseobacter species, Acidovorax species, Thiobacillus species, Pseudogulbenkiania species, Pseudomonas species, Dechloromonas species, Azospira species, Geobacter species, Desulfotignum species, Shewanella species, Rhodanobacter species, Thermomonas species, Aquabacterium species, Comamonas species, Azoarcus species, Dechlorobacter species, Propionivibrio species, Magnetospirillum species, Parvibaculm species, Paracoccus species, Firmicutal species, Desulfitobacterium species, Sporosarcina species, Bacillus species, Acidobacterial species, Geothrix species, Archaeal species, and Ferroglobus species. Preferably, the authigenic mineral-precipitating bacteria are urea oxidizing bacteria, phosphite (PO₃³⁻)-oxidizing bacteria, and ferrous iron (Fe²⁺)-oxidizing bacteria. In preferred embodiments, the authigenic mineral-precipitating bacteria are Desulfotignum species, including Desulfotignum phosphitoxidans sp. nov., Acidovorax species, or Pseudomonas species.

Such mineral-precipitating bacteria precipitate various minerals, including without limitation calcium carbonate, calcium sulfate (gypsum), magnesium carbonate, ferric oxide, ferric oxyhydroxide (e.g., maghemite, hematite, goethite, etc.), mixed valence iron minerals (e.g., magnetite, green rust, etc.), ferric phosphate, ferric carbonate, manganese oxides and mixed valence manganese minerals (e.g., hausmannite, etc.).

In some embodiments, the authigenic mineral-precipitating bacteria are selected from iron-oxidizing bacteria, nitrate-dependent Fe(II)-oxidizing bacteria, and perchlorate-reducing bacteria. In preferred embodiments, the authigenic mineral-precipitating bacteria are phosphite-oxidizing bacteria or iron-oxidizing bacteria.

Generally, authigenic mineral-precipitating bacteria of the present disclosure utilize authigenic mineral precursor solutions and authigenic mineral-precipitation inducers to induce a reaction that results in authigenic mineral precipitation. In some embodiments, the reaction is a reversible reaction. In certain embodiments, the reversible reaction is a redox reaction.

The authigenic mineral-precipitating bacteria of the present disclosure may also contain one or more of the following genes: type-b cytochrome genes, type-c cytochrome genes, type-a cytochrome genes, CODH genes, and RuBisCo genes.

### Phosphate Precipitating Bacteria

In some embodiments of the present disclosure, the authigenic mineral-precipitating bacteria are phosphite-oxidizing bacteria. Phosphite-oxidizing bacteria can precipitate solid-phase phosphate minerals from the metabolism of soluble phosphite, which couples phosphite oxidation with sulfate or carbonate reduction. These bacteria are capable of changing the valence state of added soluble phosphite precipitating out insoluble phosphate minerals, which results in the concretion of unconsolidated matrices.

Accordingly, in certain embodiments of the methods of the present disclosure, authigenic mineral-precipitating bacteria are phosphite-oxidizing bacteria that precipitate iron minerals when presented with a phosphite precursor and induced by sulfate or carbonate.

Examples of phosphite-oxidizing bacteria that may be found in rock matrix-containing systems of the present disclosure include, without limitation, Desulfotignum species, including Desulfotignum phosphitoxidans sp., Acidovorax species, or Pseudomonas species.

Phosphite-oxidizing bacteria of the present disclosure can precipitate various phosphate minerals. Examples of such iron minerals include, without limitation, calcium phosphates, magnesium phosphates, and ammonium phosphates. In preferred embodiments, phosphite-oxidizing bacteria precipitate the carbonate fluoroapatite [Ca₁₀(PO₄,CO₃)₆F₂]

### Iron Oxide Precipitating Bacteria

In some embodiments of the present disclosure, the authigenic mineral-precipitating bacteria are nitrate-dependent Fe(II)-oxidizing bacteria. Nitrate-dependent Fe(II)-oxidizing bacteria can precipitate solid-phase iron minerals from the metabolism of soluble Fe²⁺, which couples Fe(II) oxidation with nitrate reduction. These bacteria are capable of changing the valence state of added soluble ferrous iron [Fe(II)] precipitating out insoluble ferric minerals [Fe(III)], which results in which results in the concretion of unconsolidated matrices.

Accordingly, in certain embodiments of the methods of the present disclosure, authigenic mineral-precipitating bacteria are nitrate-dependent Fe(II)-oxidizing bacteria that precipitate iron minerals when presented with an Fe(II) precursor solution and induced by nitrate.

Additionally, Fe(II)-oxidizing bacteria can oxidize the Fe(II) content of native mineral phase Fe(II) in rock matrices, thus altering the original mineral structure resulting in rock weathering and mineral biogenesis. For example, Fe(II)-oxidizing bacteria can oxidize Fe(II) associated with structural iron in minerals such as almandine, an iron aluminum silicate, yielding amorphous and crystalline Fe(III) oxide minerals. In some embodiments, Fe(II) oxidation occurs at a pH of about 2.0, 2.5, 3.0, 3.5, 4.0, 4.5, 5.0, 5.5, 6.0, 6.5, 6.6, 6.7, 6.8, 6.9, 7.0, 7.1, 7.2, 7.3, 7.4, 7.5, or higher.

Moreover, in addition to nitrate, iron-oxidizing bacteria may also couple nitrite, nitric oxide, nitrous oxide; perchlorate, chlorate, chlorine dioxide, or oxygen reduction with Fe(II) oxidation.

Examples of iron-oxidizing bacteria that may be found in rock matrix-containing systems of the present disclosure include, without limitation, Chlorobium ferrooxidans, Rhodovulum robiginosum, Rhodomicrobium vannielii, Thiodiction sp., Rhodopseudomonas palustris, Rhodovulum sp., Geobacter metallireducens, Diaphorobacter sp. strain TPSY and Pseudogulbenkiania sp. strain 2002, Dechloromonas sp., Dechloromonas aromatica, Dechloromonas agitata, Azospira sp., and Azospira suillum.

Iron-oxidizing bacteria of the present disclosure can precipitate various iron minerals. Examples of such iron minerals include, without limitation, iron hydr(oxide)s; iron carbonates; Fe(III)-oxides, such as 2-line ferrihydrite, goethite, lepidocrocite, and hematite; and mixed-valence iron minerals, such as green rust, maghemite, magnetite, vivianite, almandine, arsenopyrite, chromite, siderite, and staurolite.

Fe(II)-oxidizing bacteria of the present disclosure may also oxidize solid phase Fe(II), including, without limitation, surface-bound Fe(II), crystalline Fe(II) minerals (siderite, magnetite, pyrite, arsenopyrite and chromite), and structural Fe(II) in nesosilicate (almandine and staurolite) and phyllosilicate (nontronite). This reversible oxidative transformation of solid phase Fe(II) in an anoxic environment provides an additional mechanism for rock weathering for altering authigenic rock hydrology.

### Exogenously Added Authigenic Mineral-Precipitating Bacteria

The methods of the present disclosure may utilize authigenic mineral-precipitating bacteria that are indigenous to the rock matrix-containing systems of the present disclosure. However, in systems where the indigenous population of authigenic mineral-precipitating bacteria is not sufficient to be utilized in the methods of the present disclosure, exogenous authigenic mineral-precipitating bacteria may be added to the system. For example, exogenous authigenic mineral-precipitating bacteria may be introduced into the subsurface rock matrix of an oil reservoir by adding a culture broth containing the exogenous authigenic mineral-precipitating bacteria into the injection well of an oil reservoir. Culturing media and methods of culturing bacteria are well known in the art. Suitable authigenic mineral-precipitating bacteria that may be exogenously added include any of the authigenic mineral-precipitating bacteria disclosed herein. Accordingly, in certain embodiments of any of the methods of the present disclosure, prior to providing a sulfidogenic reservoir system containing a production well and a production well environment, where the production well environment further contains authigenic mineral precipitating bacteria, authigenic mineral-precipitating bacteria are added to the system.

In other embodiments, exogenously added authigenic mineral-precipitating bacteria may be isolated from a broad diversity of environments including aquatic environments, terrestrial environments, and subsurface environments. Mutants and variants of such isolated authigenic mineral-precipitating bacteria strains (parental strains), which retain authigenic mineral-precipitating activity can also be used in the provided methods. To obtain such mutants, the parental strain may be treated with a chemical such as N-methyl-N′-nitro-N-nitrosoguanidine, ethylmethanesulfone, or by irradiation using gamma, x-ray, or UV-irradiation, or by other means well known to those practiced in the art.

The term “mutant of a strain” as used herein refers to a variant of the parental strain. The parental strain is defined herein as the original isolated strain prior to mutagenesis.

The term “variant of a strain” can be identified as having a genome that hybridizes under conditions of high stringency to the genome of the parental strain. “Hybridization” refers to a reaction in which a genome reacts to form a complex with another genome that is stabilized via hydrogen bonding between the bases of the nucleotide residues that make up the genomes. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency.” In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC.

In certain embodiments, the exogenously added authigenic mineral-precipitating bacteria can be modified, e.g., by mutagenesis as described above, to improve or enhance the authigenic mineral-precipitating activity. For instance, Fe(II)-oxidizing bacteria may be modified to enhance expression of endogenous genes which may positively regulate a pathway involved in Fe(II) oxidation. One way of achieving this enhancement is to provide additional exogenous copies of such positive regulator genes. Similarly, negative regulators of the pathway, which are endogenous to the cell, may be removed.

The genes in authigenic mineral-precipitating bacteria encoding proteins involved in authigenic mineral-precipitation may also be optimized for improved authigenic mineral-precipitating activity. As used herein, “optimized” refers to the gene encoding a protein having an altered biological activity, such as by the genetic alteration of the gene such that the encoded protein has improved functional characteristics in relation to the wild-type protein. Methods of optimizing genes are well known in the art, and include, without limitation, introducing point mutations, deletions, or heterologous sequences into the gene.

Accordingly, in certain embodiments, the exogenously added authigenic mineral-precipitating bacteria are recombinant bacteria that may contain at least one modification that improves or enhances the authigenic mineral-precipitating activity of the bacteria.

### EXAMPLES

The Examples herein describe a unique approach to controlling wormhole formation, creating a permeable zone of stable petrology, and reducing the drop in water pressure of floodwater in oil recovery through the microbial production of authigenic rock precipitants that can consolidate unconsolidated rock matrices in the borewell environments of reservoir systems. Many microbial processes are known to be involved in solid-phase mineral precipitation, which can be judiciously applied to precipitate authigenic rock minerals that can consolidate unconsolidated rock matrices. However, to date, there has been little investigation of the applicability of these precipitation events to strategies for controlling wormhole formation, for creating permeable zones of stable petrology, for reducing the drop in water pressure of floodwater in oil recovery and, generally, for preventing pressure communication between injection and production wells.

Such processes can be mediated by microorganisms, such as nitrate-dependent Fe(II)-oxidizing bacteria, which can precipitate solid-phase iron minerals from the metabolism of soluble Fe²⁺. These microorganisms are capable of changing the valence state of added soluble ferrous iron [Fe(II)] and of precipitating out an insoluble ferric mineral phase [Fe(III)] that can coat the rock environment and result in a concretion binding the unconsolidated matrix particles into a single phase. Previous studies of these microorganisms have indicated their ubiquity and activity in both extreme and moderate environments and many pure culture examples are also available.

Additional mechanisms of authigenic mineral precipitation may include biogenesis of phosphorite minerals, which can occur by stimulating high rates of microbial degradation of organic phosphorous materials liberating soluble, reactive, inorganic phosphates. Such authigenic reactions are known to be important processes in marine environments due to the high concentrations of reactive calcium in marine waters similar to that found in many oil reservoirs. Alternatively, phosphorous and biogenically formed carbon dioxide can react to form apatite minerals such as the carbonate fluoroapatite [Ca₁₀(PO₄,CO₃)₆F₂].

### Example 1

### Microorganisms can Oxidize Soluble Fe(II) Under Anaerobic Conditions Found in Subterranean Reservoir Systems and Precipitate Fe(III)-Minerals

This Example illustrates the identification and the metabolic properties of bacteria capable of oxidizing soluble Fe(II) under conditions found in subterranean environments, such as subterranean reservoir systems. Exemplary bacterial strains were identified that can oxidize soluble Fe(II) under the anaerobic and specific geochemical conditions of subterranean reservoir systems.

At circumneutral pH, ˜pH 7, and greater pH values, such as those commonly found in oil reservoirs, iron primarily exists as insoluble, solid phase minerals in divalent ferrous [Fe(II)] and trivalent ferric [Fe(III)] oxidation states′. In general, the solubility and chemical reactivity of iron is particularly sensitive to the environmental pH. The solubility of the trivalent ferric form [Fe(III)] is inversely proportional to acid pH values and below a pH value of 4.0 Fe(III) primarily exists as an aqueous ionic Fe³⁺ species.

Under the geochemical conditions of a subterranean reservoir system (e.g., absence of light, low oxygen) the abiotic oxidation of Fe(II) requires either the presence of strong oxidants, such as nitrite (NO₂), chemical catalysts, such as Cu²⁺, or otherwise extreme reaction conditions (i.e., high temperatures, high pH). Thus, abiotic Fe(II) oxidation is not expected to play a significant quantitative role in naturally occurring iron redox cycling. On the other hand, a range of microbial activities has been identified recently catalyzing the redox cycling of iron in subterranean environments. In fact, today, microbial activities are expected to significantly contribute to the oxidation of Fe(II) in the environment.

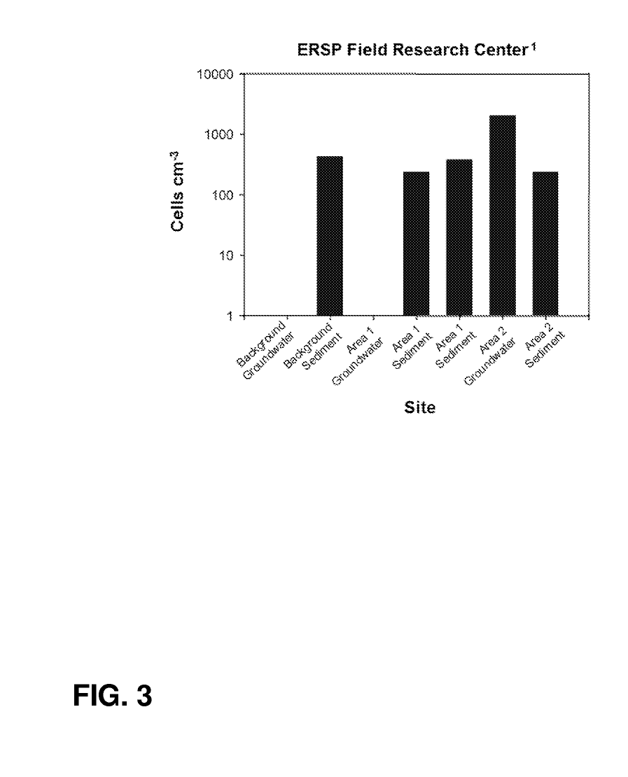

For example, at circumneutral pH, light-independent microbially mediated oxidation of both soluble and insoluble Fe(II) coupled to nitrate reduction has been demonstrated in a variety of freshwater and saline environmental systems. These environmental systems support abundant nitrate-dependent Fe(II)-oxidizing microbial communities in the order of 1×10³ to 5×10⁸ cells/g of sediment. Most probable number (MPN) enumeration studies using subsurface sediments and groundwater samples revealed similar population sizes of anaerobic nitrate-dependent Fe(II)-oxidizing organisms ranging from 0-2.4×10³ cells·cm⁻³ (FIG. 3).

MPN enumeration studies were performed by serially diluting 1 g of sediment from each sediment core interval in triplicate in 9 ml anoxic (80:20 N₂:CO₂ headspace) bicarbonate-buffered (pH 6.8) freshwater basal medium and containing 5 mM nitrate and 0.1 mM acetate as the electron acceptor and the additional carbon source, respectively. Ferrous chloride was added as the electron donor from an anoxic (100% N₂ atmosphere), filter sterilized (0.22 μm sterile nylon filter membrane) stock solution (1 M) to achieve a final concentration of 10 mM. Following the addition of 1 g sediment, sodium pyrophosphate (final concentration, 0.1%) was added to the sediment slurry, which was gently shaken at room temperature for 1 h. The sediment slurry was then serially diluted in basal medium prepared as described above. After 8 weeks of incubation in the dark at 30° C., tubes positive for iron oxidation were identified by the presence of a brownish-red or brownish-green precipitate. The Most Probable Number Calculator version 4.05 (Albert J. Klee, Risk Reduction Engineering Laboratory, U.S. Environmental Protection Agency, Cincinnati, Ohio, 1996; freeware available at EPA website) was used to enumerate the nitrate-dependent Fe(II)-oxidizing microbial community and calculate confidence limits.

Anaerobic Fe(II)-oxidizing microorganisms have also been demonstrated to exploit the favorable thermodynamics between Fe(OH₃)/Fe(II) and nitrate reduction redox pairs (NO₃⁻/½N₂, NO₃⁻/NO₂⁻, NO₃⁻/NH₄⁺)^{2,6,8,9}, as well as perchlorate (ClO₄⁻/Cl⁻), and chlorate (ClO₃⁻/Cl⁻)⁶⁸. In general, nitrite (NO₂⁻) and nitrogen gas (N₂) are considered the sole end-products of nitrate reduction^{2,3,8}. However, this may not always be the case, as it has been recently demonstrated that nitrate-dependent Fe(II) oxidation by the model Fe(III)-reducing organism Geobacter metallireducens results in the production of ammonium⁵.

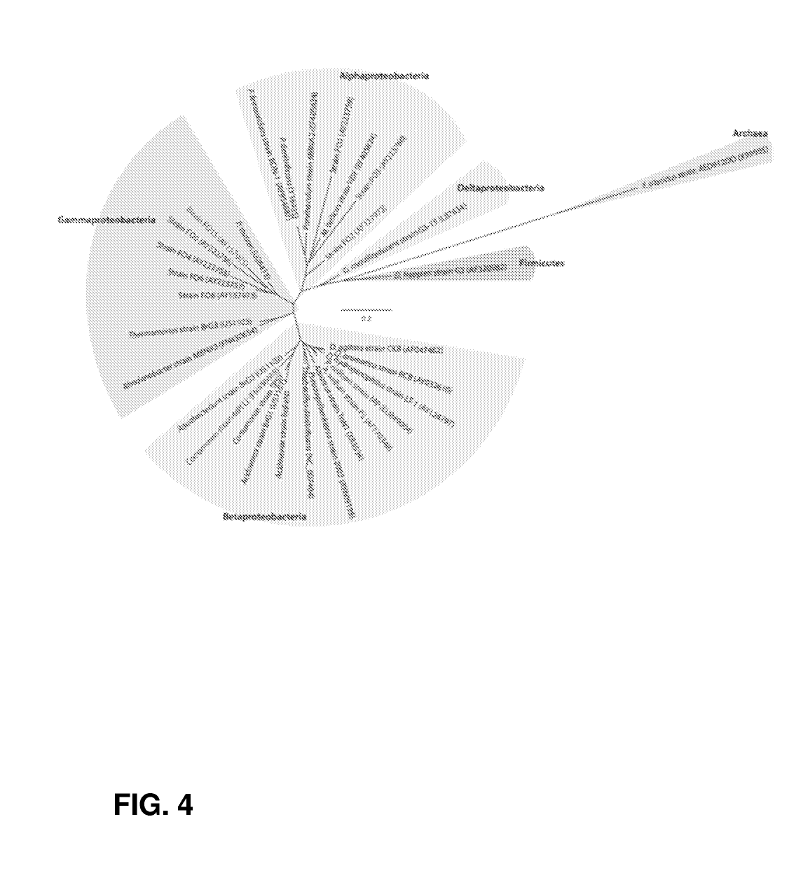

As shown in FIG. 4, nitrate-dependent Fe(II) oxidizing microorganisms are phylogenetically diverse with representatives in both the Archaea and Bacteria. To construct the phylogenetic tree shown in FIG. 4, available quality 16s rRNA gene sequences were aligned with MUSCLE (Edgar, 2004) and phylogeny was computed with MrB ayes 3.2 (Ronquist and Huelsenbeck, 2003). The scale bar in FIG. 4 indicates 0.2 changes per position.

These isolates are also physiologically diverse and represent a range of optimal thermal growth conditions from psychrophilic through mesophilic to hyperthermophilic⁷.

Although several environmentally ubiquitous and phylogenetically diverse mesophiles have been described as being capable of nitrate-dependent Fe(II) oxidation⁷, in most cases, growth was shown to not be associated with this metabolism or was not demonstrated in the absence of an additional electron donor or organic carbon as an energy source at circumneutral pH^{2,3,9,10}. In order to identify additional known mesophiles that can grow by this metabolism, we have developed a simple plate overlay technique to enrich and isolate Fe(II)-oxidizing organisms. In this technique, samples were streaked onto R2A agar plates (Difco catalog no. 218263), an undefined low-nutrient medium, and amended with 10 mM nitrate in an anaerobic glove bag (95:5 N₂:H₂ atmosphere). The plates were incubated in anaerobic jars at 30° C. for 120 h for heterotrophic colony development. An Fe(II) overlay (5 ml of R2A agar containing 2 mM FeCl₂) was poured over each plate following colony development, and incubation took place in an anoxic atmosphere. Colonies that exhibited Fe(II) oxidation, as identified by the development of brownish-red Fe(III) oxide precipitates on or around colonies, were selected and transferred into anoxic bicarbonate-buffered freshwater basal medium containing 10 mM nitrate, 10 mM Fe(II), and 0.1 mM acetate. After 1 week of incubation in the dark at 30° C., positive cultures were transferred into fresh anoxic bicarbonate-buffered basal medium containing 10 mM Fe(II) and 5 mM nitrate with CO₂ as the sole carbon source.

Using this plate overlay technique we isolated two novel bacteria Diaphorobacter sp. strain TPSY and Pseudogulbenkiania sp. strain 2002.

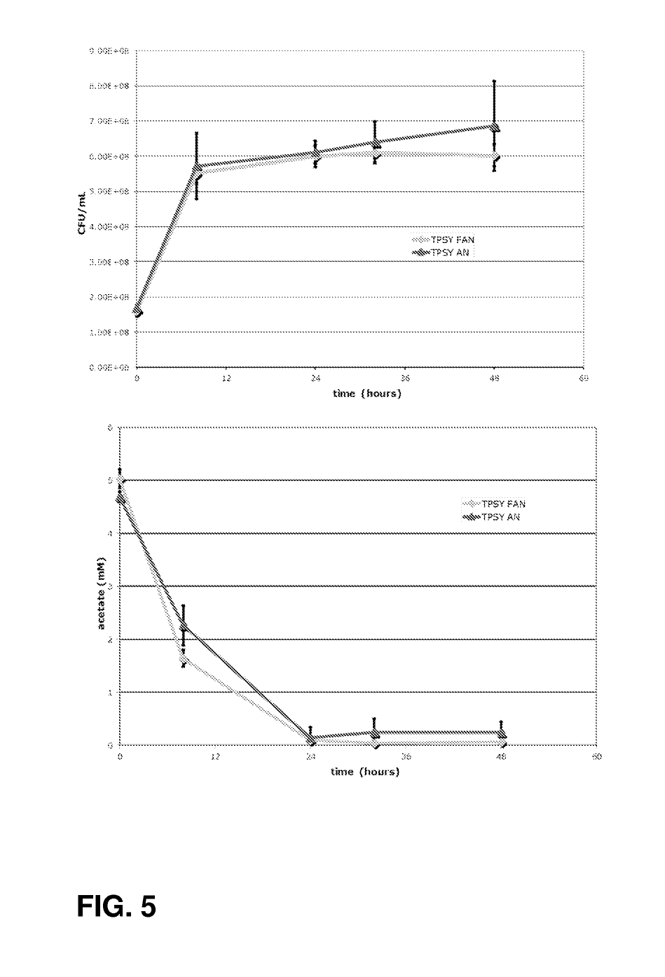

The Diaphorobacter sp. TPSY strain is a member of the beta subclass of Proteobacteria, closely related to Diaphorobacter nitroreducens in the family Comamonadaceae. Moreover, the Diaphorobacter sp. TPSY strain represents the first example of an anaerobic Fe(II)-oxidizer from this family. This organism was shown to grow mixotrophically with Fe(II) as the electron donor, acetate (0.1 mM) as a carbon source and nitrate as the sole electron acceptor (FIG. 5).

The Pseudogulbenkiania sp. strain 2002 is a member of the recently described genus, Pseudogulbenkiania, in the beta class of Proteobacteria¹¹. Its closest fully characterized relative is Chromobacterium violaceum, a known HCN-producing pathogen. In contrast to C. violaceum, Pseudogulbenkiania str. 2002 is non-fermentative and does not produce free cyanide (CN—) or the purple/violet pigments indicative of violacein production, a characteristic of Chromobacterium species. Although when tested, C. violaceum was able to oxidize Fe(II) coupled to incomplete nitrate reduction (nitrate to nitrite), but was not able to grow by this metabolism⁶.

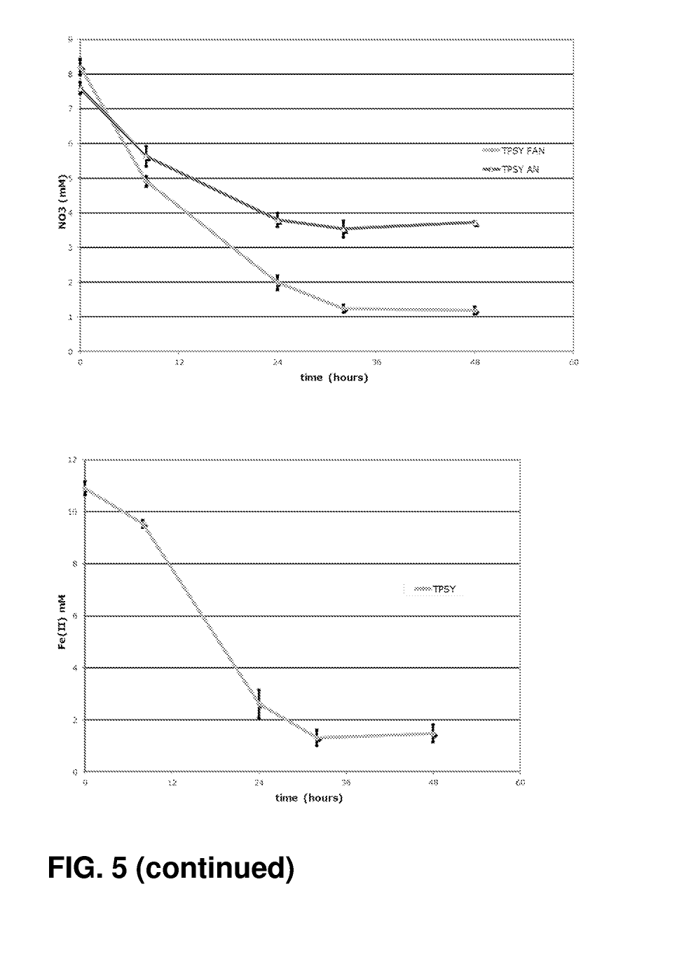

In contrast, Pseudogulbenkiania str. 2002 was shown to readily grow by nitrate-dependent Fe(II) oxidation (FIG. 6). Furthermore, in addition to its ability to grow mixotrophically on Fe(II) with acetate as a carbon source, Pseudogulbenkiania str. 2002 was also capable of lithoautotrophic growth on Fe(II) with CO₂ as the sole carbon source (FIG. 6)⁵⁷.

Cells of Pseudogulbenkiania str. 2002 grown anaerobically on acetate (10 mM) and nitrate (10 mM) were harvested by centrifugation (6,000 g, 10 min), washed twice with anaerobic (100% N2 atmosphere) PIPES [piperazine-N,N′-bis(2-ethanesulfonic acid)] buffer (10 mM, pH 7.0), and resuspended to serve as an inoculum for nongrowth experiments. A washed-cell suspension of C. violaceum was prepared with cells grown anaerobically (100% N₂ atmosphere) on nutrient broth, glucose (10 mM), and nitrate (5 mM).

The prepared washed-cell suspensions (strain 2002 or C. violaceum) were added to anaerobic PIPES (10 mM, pH 7.0) buffer amended with Fe(II) (10 mM) as the sole electron donor and nitrate (4 mM or 2.5 mM) or nitrite (2.5 mM) as the electron acceptor. Heat-killed controls were prepared by pasteurizing (80° C., 10 min) the inoculum in a hot water bath. All cell suspension incubations were performed at 30° C. in the dark, and samples were collected to monitor concentrations of Fe(II), nitrate, and nitrite.

Growth of Pseudogulbenkiania str. 2002 under nitrate-dependent Fe(II)-oxidizing conditions was verified in freshwater basal medium containing 10 mM Fe(II) and 2.2 mM nitrate with or without amendment with 0.1 mM acetate. Freshwater basal medium containing 2.2 mM nitrate without an Fe(II) source served as the negative control. Strain 2002 inoculum was grown under heterotrophic nitratereducing conditions in medium stoichiometrically balanced for nitrate (10 mM) and acetate (6.25 mM) in order to eliminate the transfer of reducing equivalents [Fe(II)] into the negative control.

The carbon compound required for growth of Pseudogulbenkiania str. 2002 under nitrate-dependent Fe(II)-oxidizing conditions was determined by inoculating an anaerobic, CO₂-free (100% N₂ atmosphere), PIPES-buffered (20 mM, pH 7.0) culture medium containing 1 mMFe(II)-nitrilotriacetic acid (NTA) and 0.25 mM nitrate with or without a carbon source amendment (1.0 mM HCO₃⁻ or 0.5 mM acetate). Strain 2002 was grown as described above in anaerobic, PIPES-buffered culture medium. The headspace of the inoculum was aseptically sparged for 15 min with 100% N₂ to eliminate CO₂ immediately prior to the initiation of the experiment.

The ability of Pseudogulbenkiania str. 2002 to assimilate CO₂ into biomass was verified by amending the nitrate-dependent Fe(II)-oxidizing growth culture medium (basal freshwater PIPES-buffered medium, 5 mM FeCl₂, 2 mM nitrate, 1 mM bicarbonate; 100% He atmosphere) with H¹⁴CO₃⁻ (final concentration, 1 μmol). Rhodospirillum rubrum grown photolithoautotrophically under an anoxic atmosphere (50:50 He:H₂ atmosphere), served as a positive control culture. Triplicate cultures were incubated statically in the dark for 60 h. A subsample (5 ml) was concentrated to a final volume of 0.5 ml by centrifugation (6,000 g, 10 min). A cell extract was prepared from the concentrated sample by three 30 sec pulses in a bead beater (Mini-Bead-Beater-8; Biospec Products, Bartlesville, Okla.) with 0.1-mm silica beads (Lysing Matrix B, Qbiogene product no. 6911-100). The lysate was chilled in an ice bath for 1 min following each pulse. The sample was then centrifuged (10,000 g, 10 min) to remove insoluble cell debris, and the soluble cell extract was withdrawn in order to determine the protein concentration and the ¹⁴C-labeled content.

Replacement of the N₂ in the headspace of Fe(II) oxidizing cultures with He did not enhance cell yield. Normalizing change in cell yield per electron transferred, indicated that the cell yield for autotrophic growth (1.45×10⁻¹¹ cells mL⁻¹ per electron transferred) was approximately 63% that of mixotrophic (Fe(II)-oxidizing with 0.25 mM acetate as carbon source) growth (2.3×10⁻¹¹ cells mL⁻¹ per electron transferred)⁶. To date, autotrophic growth under nitrate-dependent Fe(II)-oxidizing conditions has only been demonstrated in one other organism; a hyperthermophilic archaeon, Ferroglobus placidus⁸. As such, Pseudogulbenkiania str. 2002 is the first freshwater mesophilic autotrophic nitrate-dependent Fe(II)-oxidizer described in pure culture.

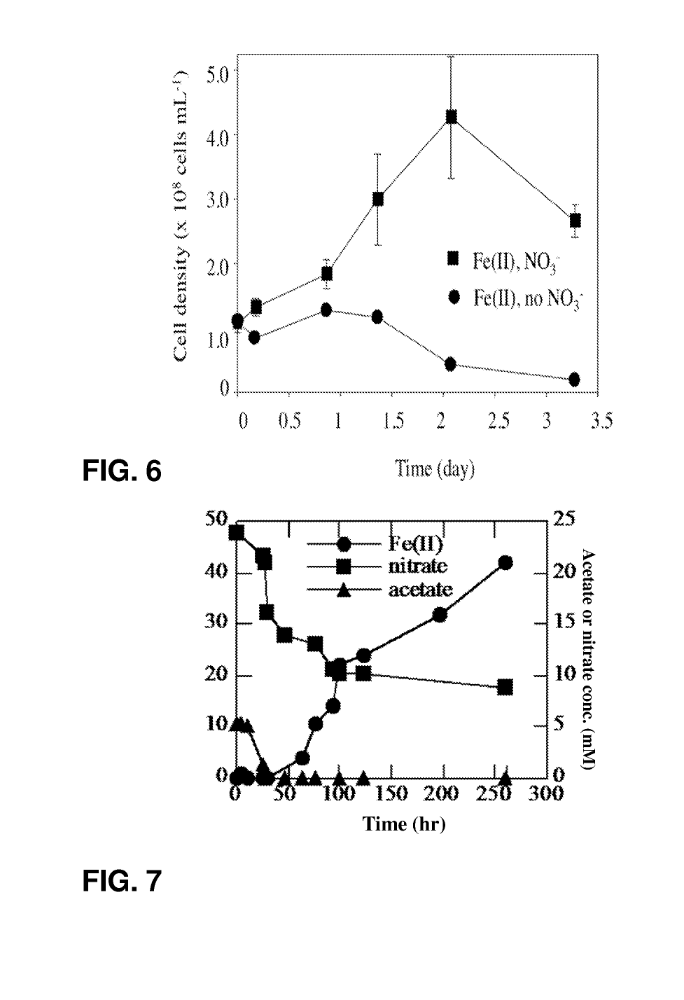

A. suillum readily oxidized (10 mM) Fe(II) in the form of FeCl₂ with nitrate as the electron acceptor under strict anaerobic conditions (FIG. 7). With 10 mM acetate as a cosubstrate, more than 70% of the added iron was oxidized within 7 days. No Fe(II) was oxidized in the absence of cells or if the nitrate was omitted (data not shown). Fe(II) oxidation was initiated after complete mineralization of acetate to CO₂, and growth was not associated with this metabolism. Nitrate reduction was concomitant with Fe(II) oxidation throughout the incubation, and the oxidation of 4.2 mM Fe(II) resulted in the reduction of 0.8 mM nitrate, which is 95% of the theoretical stoichiometry of nitrate reduction coupled to Fe(II) oxidation according to the equation.

While A. suillum readily oxidized Fe(II) in anoxic growth cultures with nitrate as the electron acceptor and Fe(II) as the sole electron donor, no cell density increase was observed throughout the incubation indicating that the organisms did not grow by this metabolism^{3,4}. When acetate was added as an additional carbon and energy source, cell density increased concomitant with acetate oxidation. Fe(II) oxidation occurred after acetate had been depleted and the culture had reached stationary phase (FIG. 7). Nitrate reduction was concomitant with Fe(II) oxidation throughout the incubation (FIG. 7), and the oxidation of 4.2 mM Fe(II) resulted in the reduction of 0.8 mM nitrate, which is 95% of the theoretical stoichiometry of nitrate reduction coupled to Fe(II) oxidation according to Formula (I):

10Fe²⁺+12H⁺+2NO₃⁻→10Fe³⁺+N₂+6H₂O

Although perchlorate and chlorate are not considered naturally abundant compounds, their potential to serve as electron acceptors in environmental systems cannot be discounted¹². Furthermore, recent evidence suggests that natural perchlorate may be far more prevalent than was first considered, given its recent discovery on Mars. Moreover, the discharge of perchlorate into natural waters has led to widespread anthropogenic contamination throughout the United States¹². Given the ubiquity of perchlorate-reducing bacteria¹² and the ability of these microorganisms, especially the environmentally dominant Azospira sp. and Dechloromonas sp.¹³, to oxidize Fe(II), anaerobic (per)chlorate-dependent Fe(II) oxidation may impact iron biogeochemical cycling in environments exposed to contaminated waters.

### Example 2

### Microbial Precipitates of Authigenic Phosphate Minerals in a Sand-Packed Column Consolidate Unconsolidated Rock Matrices and Control Wormhole Formation

Sand-packed column experiments are performed in the laboratory to demonstrate that authigenic minerals can be precipitated by microorganisms in a solid matrix and used to consolidate previously unconsolidated sand matrices. The experiments further demonstrate that matrix consolidation or concretion can control wormhole initiation and expansion, reduce pressure drops typically observed during fluid production, and delay or prevent the breakdown of production pressures.

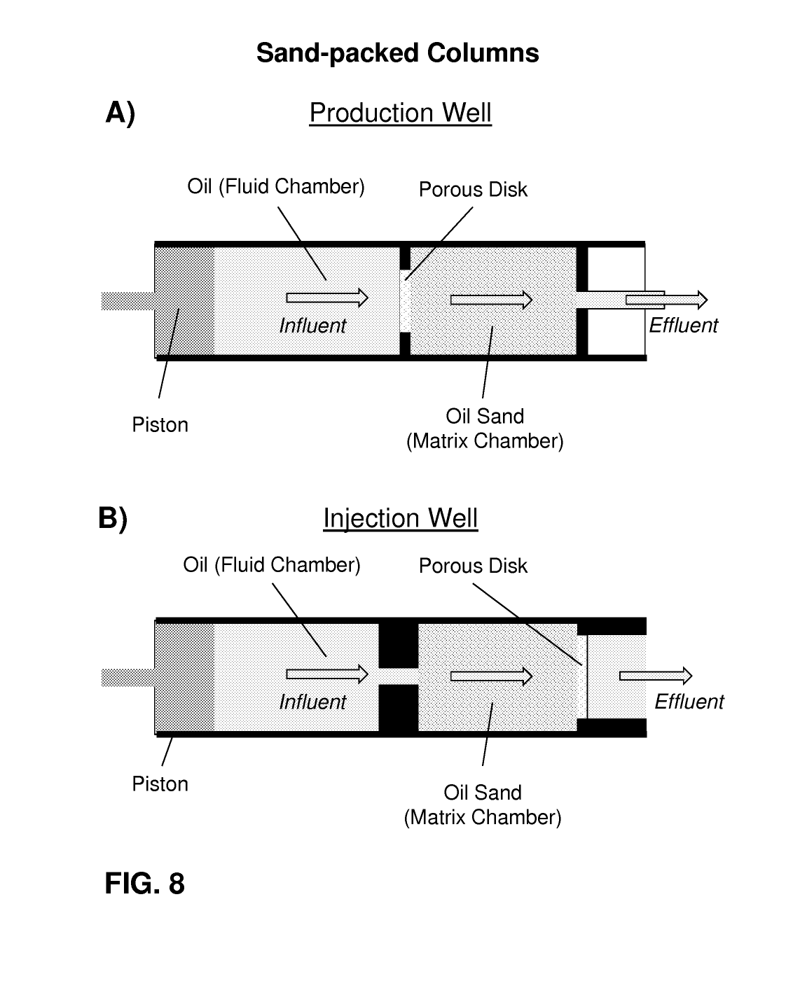

The experiment is conducted in at least two stages. First, an anaerobic phosphite oxidizing bacterium (e.g., Desulfotignum phosphitoxidans sp. nov., Acidovorax, or Pseudomonas species) is incubated with the solid matrix of a sand-packed column in the presence of an authigenic mineral precursor (e.g., a Na₃PO₃) and an authigenic mineral precipitation inducer (e.g., a 10 mM sulfate) in the presence of a precipitation partner (e.g., Ca²⁺) to precipitate authigenic calcium phosphate in the sand matrix. The presence of authigenic phosphate mineral precipitates is then confirmed. Additional analytical methods are applied to determine changes in the sand matrix's granularity, porosity, and shear resistance following mineral precipitation. In the second stage, oil is passed through the sand-packed column; oil-sand mixtures are collected at the production end of the column, production and injection pressures are continuously measured, and wormhole initiation and expansion is monitored, e.g., by computer tomography (CT). The effects of authigenic mineral precipitation and matrix concretion are assessed by comparing wormhole formation and column pressure profiles in columns containing authigenic mineral precipitates with corresponding data obtained in the absence of these precipitates. Moreover, sand-packed columns of different designs are used to demonstrate wormhole control in the injection well and production well environment respectively (see, e.g., FIGS. 8A and 8B).

It is expected that the initiation of wormhole formation will be delayed and wormhole expansion will be slowed down in sand-packed columns containing precipitated authigenic minerals that consolidate sand matrices relative to sand-packed columns that do not contain such precipitates.

### Experimental Design

FIG. 8 shows the general design of sand-packed columns as used in this experimental series. The columns have two chambers, a matrix chamber and a fluid chamber. The matrix chamber is connected to the column outlet and contains a permeable sand matrix, whereas the fluid chamber contains the matrix chamber influent. A piston is used to push the influent from the fluid chamber through the sand matrix. In sand-packed columns modeling wormhole formation at the production well, the outlet of the matrix chamber is narrow, whereas the influent enters the matrix chamber through a porous disk covering a much broader surface area than the opening of the outlet (FIG. 8A, see also FIG. 2 in Tremblay et al. “Simulation of Cold Production in Heavy-Oil Reservoirs: Wormhole Dynamics”, SPE Reservoir Engineering (May 1997) at pages 110-117). In contrast, in sand-packed columns modeling wormhole formation at the injection well, the influent enters the sand matrix through a narrow opening, whereas the column effluent exits the matrix chamber through a porous disk that has a much wider surface area (FIG. 8B).

Exemplary column specifications provide for a column length of 300-400 mm and a diameter of about 70-120 mm. The sand is wetted (e.g., 7-10 wt %), e.g., with bacterial growth medium, and packed in layers approximately 8-12 cm thick by use of a hydraulic ram at a pressure of about 13-15 MPa. The average porosity of the pack is 30-50%. The calculated pore volume (PV) is about 0.9-1.2 L. After packing the water-wetted sand, the remaining volume of the fluid chamber is then filled with another fluid, such as bacterial growth medium or clean oil (see below, depending on the experimental stage). The column is mounted horizontally in a medical CT scanner. Pressure is exerted through the piston onto the fluid in the fluid chamber and the fluid is pushed through the sand-pack. Column effluents are continuously sampled at the production end of the column Pressure sensors are placed strategically throughout the column to enable separate measurements of injection pressures and production pressures. Exemplary flow rates of fluids of 0.1-0.2 cm³/min are used and volumes of around 800-1,000 cm³ are injected, corresponding to approximately 0.8-1.0 PV.

Standard anaerobic techniques are used throughout the study. Anoxic media (pH 6.8) are prepared by boiling the medium to remove dissolved O₂ before they are dispensed under an N₂—CO₂(80:20, vol/vol) gas phase into anaerobic pressure tubes or serum bottles that are sealed with thick butyl rubber stoppers. During assembly, the sand-pack column is kept under positive N₂-pressure.

### Step 1: Precipitation of Authigenic Iron Oxide in Sand Matrix

First, the sand-packed column is equilibrated under anoxic conditions in bacterial growth media containing 10 mM fumarate as an electron donor and and 10 mM SO₄²⁻ as an electron acceptor. At the same time, a phosphite-oxidizing bacterium of the Desulfotignum phosphitoxidans species is grown and maintained in suspension cultures. Generally, bacteria are grown anaerobically at 30° C. in 100-ml infusion bottles containing medium with fumarate (10 mM) as the sole electron donor and carbon source and sulfate (10 mM) as the sole electron acceptor. After dense growth of strain 2002, cells are harvested by centrifugation at 4° C. under an N₂—CO₂ headspace. The cell pellets are washed twice and resuspended in 1 ml of anoxic bicarbonate buffer (2.5 g/l, pH 6.8) containing 80 mM phosphite ions.

The resuspended bacteria are injected at very slow flow rates (approximately 0.05 cm³/min) in a small volume (approximately 5-10% of sand matrix volume) from the fluid into the matrix chamber. The bacteria will colonize the sand matrix in the column or will be retained by the matrix such that their dwell time is much longer than the dwell time of the mobile bacterial growth medium passing through the matrix. Next, a bacterial growth medium containing phosphite ions (1.0 mM) as authigenic mineral precursors, sulfate (10 mM) as a precipitation inducer and calcium ions as a precipitation partner is pushed from the liquid chamber into the matrix chamber and incubated with authigenic mineral precipitating bacteria the sand matrix for a duration of several hours to several days. During this time bacterial growth medium is continuously pushed through the sand matrix at very slow flow rates and both injection and production pressures are continuously monitored to determine the impact of the progressing mineral precipitation and matrix concretion on the column pressures and matrix permeability. With increasing mineralization and concretion of the sand matrix, column pressures are expected to increase and the sand content in effluents are expected to decrease.

To optimize iron oxide precipitation condition, preliminary experiments are conducted, wherein samples of the column's sand matrix are taken at regular intervals and the presence of precipitated iron oxide is confirmed and quantified by means of an X-ray diffraction analysis of biogenic precipitants, or a determination of total phosphate content using a standard HPLC assay. As the bacterial cells are loaded onto the column and incubated with column materials, samples of column effluents are taken and tested for the presence of strain 2002 cells, using either colony formation assays or OD₆₀₀ measurements.

Control experiments are conducted to confirm the microbial origin of authigenic iron precipitates. These control experiments involve either the use of heat inactivated bacteria or test for chemical iron oxide precipitation occurring in the absence of bacterial cells.

### Step 2: Monitoring Wormhole Formation in Sand Matrix

Once the precipitation of authigenic phosphate minerals in the sand-packed column has been confirmed, the column is equilibrated with oil at a flow rate of about 0.2 cm³/min. Preferably, the oil used for this stage of the experiment is crude oil. In preparation for the experiment, the crude oil is first diluted with toluene and centrifuged several times to remove the fines. The toluene is then removed by heating the oil. The viscosity of the oil at reservoir temperature (approximately 18° C.) is about 27 Pa*s. The second stage of the experiment is performed at this same temperature.

After equilibration of the column, the flow rate is increased from about 0.2 cm³/min to about 0.6 cm³/min Just before this increase in the flow rate the CT scanning of the matrix chamber commences and effluent samples are collected for the concomitant determination of sand contents.

Control experiments are performed, wherein the oil is passed over unmodified sand-packed columns of equal volume that do not contain authigenic iron oxide precipitates.

### Example 3

### Microbial Precipitates of Authigenic Phosphate Minerals in a Borewell Environment of an Oil Field Consolidate Unconsolidated Rock Matrices and Control Wormhole Formation

Experiments are performed in an oil field to demonstrate that authigenic phosphate minerals can be precipitated in the rock matrix of an oil field's borewell environment and that the precipitated phosphate minerals consolidate previously unconsolidated rock matrices and control wormhole formation. The experiments are performed in oil fields where oil recovery has just been initiated or, alternatively, in more mature oil fields where oil recovery has proceeded for some time. However, no MBEs have occurred in the field prior to the experiment or, alternatively, preexisting wormholes were plugged by traditional methods after the MBE occurred. Experiments are performed at injection or production wells.

The experiments are performed in at least two stages. First, the respective borewell environment is incubated with an authigenic mineral precipitation inducer (e.g., a sulfate solution). In the second stage, oil is produced at the production well. The produced oil is continuously sampled for its sand and water contents and the pressure differential between the injection and production borewell bottoms is continuously measured. In one series of experimental permutations, the borewell bottom pressure differentials and water or sand contents of produced oil is followed both over time and as a function of the injected water pressure, both before and after precipitation of authigenic minerals in respective borewell environments.

### Stage 1: Authigenic Precipitation of Phosphate Minerals in Production Well Environment

During stage 1 of the experiment, authigenic mineral precursor and precipitation inducer solutions are injected into the borewell environment and the greater oil field though either the injection well, the production well, or both wells (see, e.g., FIG. 1A). Oil is not produced from the production well at this time. Depending on the size of the oil field, the size and design of the production well, the geology of the rock matrix, applicable flow rates and reagent concentrations, the time of injection of the precursor and inducer solutions may range from hours to days. Moreover, depending on the nature and reactivity of the precursor and inducer reagents used, the respective reagents may be injected either as a premixed solution or separately. In the latter case, the precursor solution is typically injected first. Again, depending on the nature and reactivity of the precursor and inducer reagents used, an interim incubation and dissipation time may be allowed for between the injection of the precursor solution and the precipitation inducer. This dissipation time period may range from a few hours to several days. Without wishing to be bound by theory, this interim time period allows the precursor solution to more fully penetrate the rock matrix before the presence of the inducer triggers precipitation of the authigenic rock minerals.

The experimental design provides for an additional incubation period after completion of stage 1 and prior to initiation of stage 2. Without wishing to be bound by theory, this incubation period is intended to allow sufficient time for the optimal precipitation of authigenic rock minerals in the production well environment.

Stage 2: Production of Oil from Reservoir Containing Borewell Environments with Consolidated Rock Matrixes

During stage 2 of the experiment oil production from the production well is resumed. The sand and water content of the produced oil is first tested prior to initiation of stage 1 of the experiment and is continuously sampled during the execution of stage 2. Similarly, the pressure differential between the injection and production well bottoms is measured both prior to the commencement of stage 2 and all through the oil production phase of stage 2.

Further sampling is conducted to confirm the presence of authigenic phosphate mineral precipitates in the rock matrix of the production well environment. One possible way to confirm the presence of phosphate mineral precipitates is to analyze sediment materials, such as oil sands, that are by-products of the oil-recovery process and contain particles washed out from the rock matrix of the production well environment.

The presence of authigenic rock mineral precipitating bacteria in the production well environment is confirmed through sampling of sediments produced at the production well or sampling of the production well's rock matrix. In at least some experiments, combinations of authigenic mineral precipitation inducers and precursor solutions are used that do not effectively induce the (chemical) precipitation of authigenic rock minerals in the absence of mineral precipitating bacteria. In some variations of the described experiment authigenic mineral precipitating bacteria are further added to the production well environment. These added bacteria are grown and cultured in the laboratory or an industrial-scale fermentation facility. Bacterial suspensions are added to the reservoir prior to initiation of stage 1 through injection through the production well environment. In some variations of the described experiments authigenic precipitation inducers, such as calcium ions are added to the production environment.

### REFERENCES

1 Cornell, R. M. & Schwertmann, U. The iron oxides: Structure, properties, reactions, occurrences and uses. 2 edn, (WILEY-VCH, 2003).
2 Straub, K. L., Benz, M., Schink, B. & Widdel, F. Anaerobic, nitrate-dependent microbial oxidation of ferrous iron. Appl. Environ. Microbiol. 62, 1458-1460 (1996).
3 Chaudhuri, S. K., Lack, J. G. & Coates, J. D. Biogenic magnetite formation through anaerobic biooxidation of Fe(II). Appl. Environ. Microbiol. 67, 2844-2848 (2001).
4 Lack, J. G., Chaudhuri, S. K., Chakraborty, R., Achenbach, L. A. & Coates, J. D. Anaerobic biooxidation of Fe(II) by Dechlorosoma suillum. Microb Ecol 43, 424-431 (2002).
5 Weber, K. A., Urrutia, M. M., Churchill, P. F., Kukkadapu, R. K. & Roden, E. E. Anaerobic redox cycling of iron by freshwater sediment microorganisms. Environ. Microbiol. 8, 100-113 (2006).
6 Weber, K. A. et al. Anaerobic nitrate-dependent iron(II) bio-oxidation by a novel, lithoautotrophic, Betaproteobacterium, Strain 2002. Appl. Environ. Microbiol. 72, 686-694 (2006).
7 Weber, K. A., Achenbach, L. A. & Coates, J. D. Microbes Pumping Iron: Anaerobic Microbial Iron Oxidation and Reduction. Nature Rev. Microbiol. (2006).
8 Hafenbradl, D. et al. Ferroglobus placidus gen. nov., sp. nov. a novel hyperthermophilic archaeum that oxidizes Fe²⁺ at neutral pH under anoxic conditions. Arch. Microbiol. 166, 308-314 (1996).
9 Bruce, R. A., Achenbach, L. A. & Coates, J. D. Reduction of (per)chlorate by a novel organism isolated from a paper mill waste. Environ Microbiol 1, 319-331 (1999).
10 Shelobolina, E. S., VanPraagy, C. G. & Lovley, D. R. Use of ferric and ferrous iron containing minerals for respiration by Desulfitobacterium frappieri. Geomicrobiol. J. 20, 143-156 (2003).
11 Weber, K. A. et al. Physiological and taxonomic description of the novel autotrophic, metal oxidizing bacterium, Pseudogulbenkiania sp. strain 2002. Appl. Microbiol Biotechnol. 83, 555-565 (2009).
12 Coates, J. D. & Achenbach, L. A. Microbial perchlorate reduction: Rocket-fuelled metabolism. Nature Rev. Microbiol. 2, 569-580 (2004).
13 Coates, J. D. et al. The ubiquity and diversity of dissimilatory (per)chlorate-reducing bacteria. Applied and Environmental Microbiology 65, 5234-5241 (1999).

1. A method of controlling wormhole formation or creating a permeable zone of stable petrology in a borewell environment by microbial concretion, the method comprising:
a) providing a system comprising a borewell and a borewell environment, wherein the borewell environment comprises an unconsolidated rock matrix and authigenic mineral precipitating bacteria;
b) providing an authigenic mineral precursor solution and an authigenic mineral-precipitation inducer; and
c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby controlling wormhole formation in the borewell environment or creating a permeable zone of stable petrology in the borewell environment.

2. (canceled)

3. A method of reducing the drop in water pressure of floodwater in oil recovery by microbial concretion, the method comprising:
a) providing a system comprising a borewell and a borewell environment, wherein the borewell environment comprises an unconsolidated rock matrix, floodwater, and authigenic mineral-precipitating bacteria;
b) providing an authigenic mineral precursor solution and an authigenic mineral-precipitation inducer; and
c) contacting the borewell environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby reducing the drop in water pressure of floodwater in oil recovery.

4. A method of controlling waterfinger formation in an injection well environment by microbial concretion, the method comprising:
a) providing a system comprising an injection well and an injection well environment, wherein the injection well environment comprises an unconsolidated rock matrix and authigenic mineral precipitating bacteria;
b) providing an authigenic mineral precursor solution and an authigenic mineral-precipitation inducer; and
c) contacting the injection well environment with the authigenic mineral precursor solution and the authigenic mineral-precipitation inducer under conditions whereby the inducer induces the bacteria to precipitate authigenic mineral from the solution into the unconsolidated rock matrix, wherein the precipitated authigenic mineral consolidates the unconsolidated rock matrix, thereby controlling waterfinger formation in the injection well environment.

5. The method of claim 1, wherein the precipitated authigenic mineral comprises at least one authigenic precipitation partner and wherein at least one precipitation partner was added to the system.

6. The method of claim 5, wherein the at least one precipitation partner is Ca²⁺, Mg²⁺, NH₄⁺, PO₄³⁻, CO₃²⁻, or F⁻.

7. The method of claim 5, wherein the precipitation partner is added in combination with the authigenic mineral precursor, or in combination with the authigenic mineral precursor and the authigenic mineral precipitation inducer.

8-9. (canceled)

10. The method of claim 1, wherein the borewell is an injection well or a production well.

11-18. (canceled)

19. The method of claim 1, wherein the borewell environment is contacted with the authigenic mineral precursor solution and the authigenic mineral-precipitation inducer under conditions whereby the inducer further induces the precursor to chemically precipitate authigenic rock mineral from the solution into the unconsolidated rock matrix, wherein the precipitated authigenic mineral consolidates the unconsolidated rock matrix.

20. The method of claim 1, wherein the system is selected from the group consisting of an oil reservoir; a natural gas reservoir; an aquifer; a wastewater reservoir containing effluent from a pulp, paper, or textile mill or a tannery; and a CO₂ storage well.

21-27. (canceled)

28. The method of claim 1, wherein the authigenic mineral-precipitating bacteria are selected from the group consisting of iron-reducing bacteria, iron-oxidizing bacteria, nitrate-dependent Fe(II)-oxidizing bacteria, fermentative bacteria, phosphite-oxidizing bacteria, perchlorate-reducing bacteria, chlorate-reducing bacteria, nitrate-reducing bacteria, urea oxidizing bacteria, calcium mineral precipitating bacteria, apatite mineral precipitating bacteria, ammonium carbonate mineral-precipitating bacteria, magnesium mineral precipitating bacteria, silicate mineral precipitating bacteria, manganese mineral-precipitating bacteria, sulfur mineral-precipitating bacteria, iron-precipitating bacteria, and phosphorous mineral-precipitating bacteria.

29-30. (canceled)

31. The method of claim 1, wherein the authigenic mineral precursor solution is selected from the group consisting of an Fe(II) solution, an ammonia solution, a urea solution, a phosphate solution, a phosphite solution, a calcium solution, a carbonate solution, and a magnesium solution

32. (canceled)

33. The method of claim 1, wherein the authigenic mineral-precipitation inducer is selected from the group consisting of nitrate, nitrite, nitrous oxide, nitric oxide, perchlorate, chlorate, chlorite, chlorine dioxide, Fe(III), carbonate, bicarbonate, CO₂, sulfate, and oxygen.

34-37. (canceled)

38. The method of claim 1, wherein the authigenic mineral is selected from a group consisting of calcium carbonate, calcium sulfate, calcium phosphate, magnesium carbonate, magnesium phosphate, ferric oxide, ferric oxyhydroxide, mixed valence iron minerals, ferric phosphate, ferrous phosphate, ferric carbonate, ferrous carbonate, manganese oxides, mixed valence manganese minerals, and ammonium phosphates.

39. The method of claim 1, wherein the authigenic mineral is an apatite or struvite mineral.

40. The method of claim 1, wherein the authigenic mineral is the carbonate fluoroapatite [Ca₁₀(PO₄,CO₃)₆F₂].

41. (canceled)

42. The method of claim 1, wherein the precipitated authigenic rock minerals consolidate up to 1%, 2%, 4%, 6%, 8%, 10%, 15%, 20%, 30%, 40%, 50%, 60%, 70%, 80%, 90%, 95%, 98%, 99%, 99.9% of the unconsolidated rock matrix in the borewell environment.

43. The method of claim 1, wherein the density of the consolidated rock matrix is highest in direct proximity to the borewell bottom and decreases from the borewell bottom towards the outer limits of the borewell environment.

44. The method of claim 43, wherein the density of the consolidated rock matrix at the outer limits of the borewell environment has decreased by at least 1%, 2%, 3%, 4%, 5%, 6%, 7%, 8%, 9%, 10%, 15%, or 20% relative to the density of the rock matrix in direct proximity to the borewell bottom.

45. (canceled)

46. The method of claim 1, wherein the borewell is an injection well and authigenic mineral precipitation and matrix consolidation reduces the pressure differential between injection well environment areas having unconsolidated rock matrix and the injection well bottom by at least 10%, 20%, 30%, 40%, 50%, 60%, 70% or 80% relative to the pressure differential observed prior to execution of step c).

47. The method of claim 1, wherein after execution of step c) the pressure differential between injection well and production well bottoms increases by at least 1%, 3%, 5%, 10%, 20%, 30%, 40%, or 50% relative to the pressure differential observed prior to execution of step c).
